(19) United States
(12) Patent Application Publication
(10) Pub. No.: US 2026/0253580 A1
(43) Pub. Date: Aug. 27, 2026

(54) SYSTEM

(71) Applicant: SoftBank Group Corp., Tokyo (JP)

(72) Inventor: Yu EMA, Tokyo (JP)

(73) Assignee: SoftBank Group Corp., Tokyo (JP)

(21) Appl. No.: 19/539,176

(22) Filed: Feb. 13, 2026

(30) Foreign Application Priority Data
Feb. 21, 2025 (JP) 2025-026969

(51) Int. Cl. G10L 15/06; G06F 40/30

(52) U.S. Cl. CPC G10L 15/063; G06F 40/30

(57) ABSTRACT

The system according to the embodiment comprises an imaging unit, a transcription unit, an analysis unit, and a visualization unit. The imaging unit captures a talk. The transcription unit transcribes the talk captured by the imaging unit. The analysis unit analyzes the talk transcribed by the transcription unit. The visualization unit visualizes points of the talk analyzed by the analysis unit.

### CROSS-REFERENCE TO RELATED APPLICATION

The present application claims priority to and incorporates by reference the entire contents of Japanese Patent Application No. 2025-026969 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, efficient analysis of the content of a talk and visualization of points have not been sufficiently performed, leaving room for improvement.

### SUMMARY OF THE INVENTION

The system according to the embodiment comprises an imaging unit, a transcription unit, an analysis unit, and a visualization unit. The imaging unit captures a talk. The transcription unit transcribes the talk captured by the imaging unit. The analysis unit analyzes the talk transcribed by the transcription unit. The visualization unit visualizes points of the talk analyzed by the analysis unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

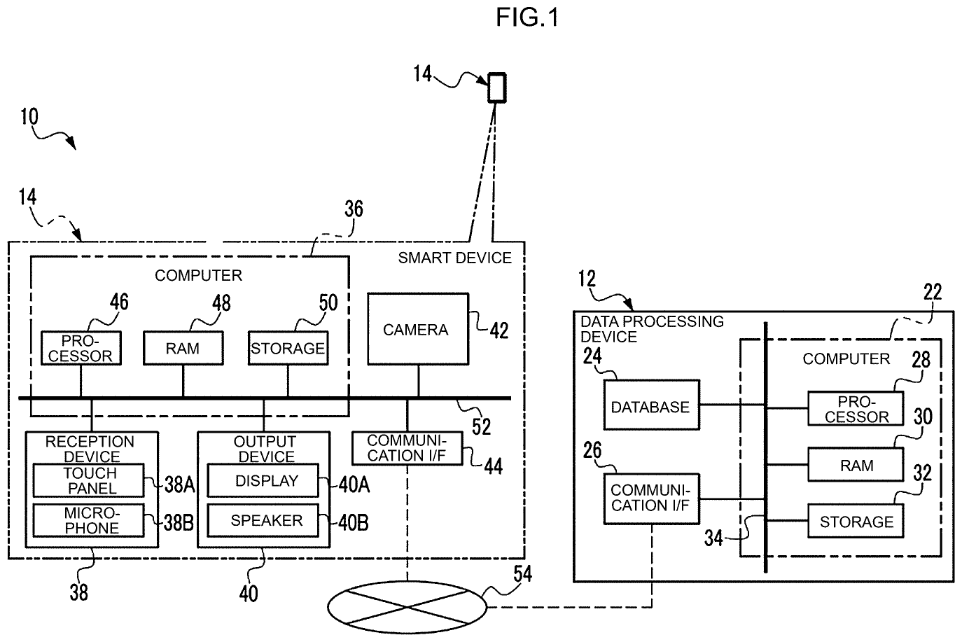

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

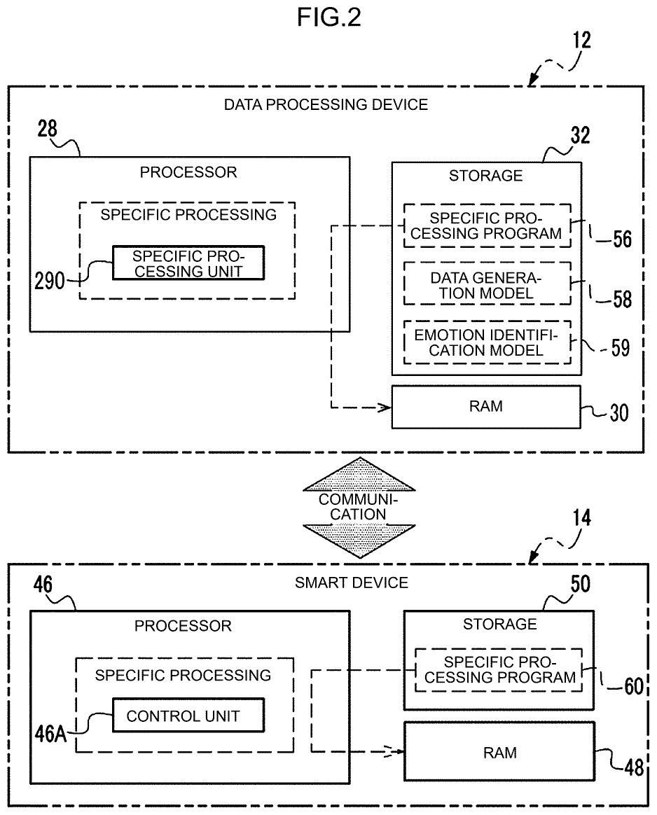

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The talk analysis system according to the embodiment of the present invention is a system that captures the talk of excellent crew members in a shop, transcribes the talk using a transcription function, and further loads the transcribed talk into SmartAI-Chat to concisely visualize the points of the talk. This talk analysis system captures the talk of excellent crew members in a shop, transcribes the talk using a transcription function, and further loads the transcribed talk into SmartAI-Chat to concisely visualize the points of the talk. For example, the talk analysis system captures the talk of excellent crew members using ZOOM. For example, it captures talks during customer service or product explanations. At this time, by capturing the crew's facial expressions and gestures as well, more detailed information can be obtained. Next, the talk analysis system transcribes the captured talk using a transcription function. For example, by using ZOOM's transcription function, the content of the talk is automatically transcribed. The transcribed talk is used as data for later analysis. Next, the talk analysis system loads the transcribed talk into SmartAI-Chat. SmartAI-Chat uses AI to analyze the content of the talk and extract important points. For example, it can extract important phrases during customer service or key points of product explanations. Finally, the talk analysis system concisely visualizes the extracted points. For example, by visually displaying them using graphs or charts, the key points of the talk can be grasped at a glance. In this way, the content of the talk can be efficiently analyzed and utilized for the education and training of other crew members. As a result, the talk analysis system can efficiently grasp the key points of the talk and utilize them for the education and training of other crew members. Specifically, this talk analysis system is composed of multiple hardware and software modules, namely an imaging unit, a transcription unit, an analysis unit, and a visualization unit. The imaging unit, for example, uses a high-resolution camera or multiple angle cameras to simultaneously record the crew's voice, facial expressions, and gestures. The recorded data is stored as an RGB image tensor (e.g., 1920×1080×3) for video, and as a one-dimensional waveform array with a sampling rate of 16 kHz for audio. The transcription unit takes audio data as input, extracts acoustic features (MFCC, spectrogram, etc.), and uses convolutional neural networks (CNN), recurrent neural networks (RNN), or Transformer-based speech recognition models to generate a text sequence (e.g., “Welcome. How may I help you today?”) from the audio waveform. Examples of AI input include audio waveform arrays (float arrays of length 160,000), video frame sequences (image tensors for 10 seconds at 30 fps), or multimodal tensors combining these. Examples of AI output include transcription text (UTF-8 encoded string), confidence scores for each utterance segment (0.0-1.0), and speaker separation labels (e.g., speaker_1, speaker_2). The analysis unit takes the transcription text as input, first performs morphological analysis and dependency parsing, and then, using a Transformer-based large language model (LLM), executes important phrase extraction, summary generation, and sentiment analysis (e.g., positive, neutral, negative). Examples of input include the full talk text (several thousand characters), and examples of output include a list of important points (e.g., “product feature explanation,” “closing talk”), summary sentences (e.g., “This talk includes a new product feature explanation and closing”), and sentiment scores (e.g., 0.85). In subsequent processing, the output of the analysis unit is passed to the visualization unit, which displays the extracted points in formats such as graphs (bar graphs, pie charts), charts (timelines), and highlight displays (colored text) on a web UI or digital signage. The visualization unit also enables interactive operations on the user interface (e.g., click for details, filtering). This series of processes, unlike conventional manual work or simple automation, uses AI models to extract patterns in high-dimensional feature space and perform inference using learned weights rather than rule-based methods, thereby greatly improving accuracy, speed, and reproducibility. Technical effects include improved analysis accuracy of talk content, ensuring real-time performance, immediate application to education and training, and efficient knowledge sharing through database creation. Specific application fields include education in customer service, operator guidance in call centers, quality management of sales talks, analysis of medical interview records, and automatic summarization of meeting minutes, among others.

The talk analysis system according to the embodiment comprises an imaging unit, a transcription unit, an analysis unit, and a visualization unit. The imaging unit captures a talk. The talk may include, for example, presentations, meetings, interviews, but is not limited to such examples. The imaging unit, for example, captures the talk of excellent crew members using ZOOM. For example, it captures talks during customer service or product explanations. At this time, by capturing the crew's facial expressions and gestures as well, more detailed information can be obtained. The transcription unit transcribes the talk captured by the imaging unit. Transcription may include, for example, speech recognition technology or manual input, but is not limited to such examples. For example, by using ZOOM's transcription function, the content of the talk is automatically transcribed. The transcribed talk is used as data for later analysis. The analysis unit analyzes the talk transcribed by the transcription unit. Analysis may include, for example, keyword extraction or sentiment analysis, but is not limited to such examples. For example, SmartAI-Chat uses AI to analyze the content of the talk and extract important points. For example, it can extract important phrases during customer service or key points of product explanations. The visualization unit visualizes the points of the talk analyzed by the analysis unit. Visualization may include, for example, graph display or highlight display, but is not limited to such examples. For example, by visually displaying them using graphs or charts, the key points of the talk can be grasped at a glance. As a result, the talk analysis system according to the embodiment can efficiently grasp the key points of the talk and utilize them for the education and training of other crew members. Specifically, this talk analysis system is composed of multiple hardware and software modules, namely an imaging unit, a transcription unit, an analysis unit, and a visualization unit. The imaging unit uses a high-resolution camera or multiple angle cameras to simultaneously record the crew's voice, facial expressions, and gestures. The recorded data is stored as an RGB image tensor (e.g., 1920×1080×3) for video, and as a one-dimensional waveform array with a sampling rate of 16 kHz for audio. The transcription unit takes audio data as input, extracts acoustic features (MFCC, spectrogram, etc.), and uses convolutional neural networks (CNN), recurrent neural networks (RNN), or Transformer-based speech recognition models to generate a text sequence (e.g., “Welcome. How may I help you today?”) from the audio waveform. Examples of AI input include audio waveform arrays (float arrays of length 160,000), video frame sequences (image tensors for 10 seconds at 30 fps), or multimodal tensors combining these. Examples of AI output include transcription text (UTF-8 encoded string), confidence scores for each utterance segment (0.0-1.0), and speaker separation labels (e.g., speaker_1, speaker_2). The analysis unit takes the transcription text as input, first performs morphological analysis and dependency parsing, and then, using a Transformer-based large language model (LLM), executes important phrase extraction, summary generation, and sentiment analysis (e.g., positive, neutral, negative). Examples of input include the full talk text (several thousand characters), and examples of output include a list of important points (e.g., “product feature explanation,” “closing talk”), summary sentences (e.g., “This talk includes a new product feature explanation and closing”), and sentiment scores (e.g., 0.85). In subsequent processing, the output of the analysis unit is passed to the visualization unit, which displays the extracted points in formats such as graphs (bar graphs, pie charts), charts (timelines), and highlight displays (colored text) on a web UI or digital signage. The visualization unit also enables interactive operations on the user interface (e.g., click for details, filtering). This series of processes, unlike conventional manual work or simple automation, uses AI models to extract patterns in high-dimensional feature space and perform inference using learned weights rather than rule-based methods, thereby greatly improving accuracy, speed, and reproducibility. Technical effects include improved analysis accuracy of talk content, ensuring real-time performance, immediate application to education and training, and efficient knowledge sharing through database creation. Specific application fields include education in customer service, operator guidance in call centers, quality management of sales talks, analysis of medical interview records, and automatic summarization of meeting minutes, among others.

The imaging unit may comprise an audio processing unit that uses noise canceling or voice filtering technology. Noise canceling may include, for example, active noise canceling or passive noise canceling, but is not limited to such examples. For example, active noise canceling is a technology that detects ambient noise using microphones and generates sound with an inverted phase to cancel the noise. Passive noise canceling is a technology that blocks noise using physical barriers. Voice filtering may include, for example, frequency filtering or echo canceling, but is not limited to such examples. For example, frequency filtering is a technology that emphasizes or attenuates voice in specific frequency bands. Echo canceling is a technology that removes echo components from voice signals. This enables the removal of noise and unwanted sounds to obtain clear audio. Some or all of the above-described processing in the audio processing unit may be performed using AI or without using AI. For example, the audio processing unit may input audio data obtained using noise canceling or voice filtering technology into generative AI and have the generative AI perform audio clarification. Specifically, the imaging unit is equipped with a digital signal processing circuit or dedicated processor as the audio processing unit, and processes input audio signals (e.g., one-dimensional float array sampled at 16 kHz, length 160,000 samples) in real time. In the case of active noise canceling, the audio processing unit implements an algorithm (e.g., adaptive filter, LMS algorithm) that separates environmental noise signals and target voice signals obtained from multiple microphones and generates inverted phase signals. In the case of passive noise canceling, the audio processing unit blocks external noise by the physical arrangement of microphones or housing design. In frequency filtering, the audio processing unit calculates the frequency spectrum using FFT (Fast Fourier Transform) and applies a band-pass filter that attenuates frequencies outside the specific band (e.g., 300 Hz-3400 Hz voice band). In echo canceling, the audio processing unit estimates echo components using autocorrelation analysis or adaptive filters and subtracts them from the original signal. When using AI, the audio processing unit inputs audio waveform tensors or spectrogram images (e.g., 256×256 two-dimensional float array) and uses convolutional neural networks (CNN) or autoregressive models (RNN, LSTM) to estimate noise masks and enhance voice. Examples of AI input include noise-contaminated audio waveforms (e.g., conversation+air conditioning noise), spectrogram images, and environmental noise profiles. Examples of AI output include noise-removed audio waveforms, noise mask arrays (0.0-1.0), and SNR (signal-to-noise ratio) scores for each audio segment. In subsequent processing, the clarified audio data is passed to the transcription unit and used as input for acoustic feature extraction and speech recognition models. Unlike conventional simple filtering or manual noise removal, the AI model learns to separate noise and voice in high-dimensional feature space in real time and with high accuracy. Technical effects include improved speech recognition accuracy, reduced misrecognition rate, adaptation to diverse recording environments, and stabilization of subsequent AI processing. Specific application fields include call center call record analysis, meeting minutes creation, medical interview records, lecture recording in educational settings, and voice interfaces in noisy environments.

The analysis unit may comprise a classification unit configured to classify the content of the talk. Classification may include, for example, topic-based classification or emotion-based classification, but is not limited to such examples. For example, topic-based classification is a method of classifying the content of the talk based on specific topics. Emotion-based classification is a method of classifying the content of the talk based on the speaker's emotion. The classification unit may analyze the content of the talk and classify it based on specific topics. The classification unit may also analyze the content of the talk and classify it based on the speaker's emotion. For example, the classification unit may analyze the content of the talk and classify parts expressing positive emotions and parts expressing negative emotions. This enables efficient classification of the content of the talk and extraction of important points. Some or all of the above-described processing in the classification unit may be performed using AI or without using AI. For example, the classification unit may input the content of the talk into generative AI and have the generative AI perform topic-based or emotion-based classification. Specifically, the classification unit receives the full talk text obtained from the transcription unit (e.g., several thousand characters of UTF-8 encoded text) as input, first performs morphological analysis and part-of-speech tagging, and generates feature vectors (e.g., BERT embedding vectors, dimension 768) for each sentence or utterance. In topic-based classification, the classification unit uses a pre-trained supervised multi-class classification model (e.g., Transformer-based text classifier, SVM, random forest, etc.) to classify each utterance or sentence into predefined categories such as “product explanation,” “closing,” “greeting,” etc. In emotion-based classification, the classification unit uses an emotion analysis model (e.g., bidirectional LSTM+attention, or large language model) to estimate emotion labels (e.g., positive, neutral, negative) and emotion scores (e.g., 0.92) for each utterance. Examples of AI input include the full talk text, sentence-level text arrays, or talk history data with contextual information. Examples of AI output include topic label arrays for each sentence or utterance (e.g., [‘product explanation’, ‘closing’, ‘greeting’]), emotion label arrays (e.g., [‘positive’, ‘neutral’, ‘negative’]), and confidence scores for each label (e.g., 0.85, 0.60, 0.95). In subsequent processing, classification results are used for important point extraction, graph generation in the visualization unit, summary generation, and educational feedback. Unlike conventional subjective classification by humans or simple keyword matching, the classification unit achieves pattern learning in high-dimensional feature space and context-dependent classification, greatly improving classification accuracy, reproducibility, and processing speed. Technical effects include improved automatic classification accuracy of talk content, visualization of emotional changes, immediate application to education and quality management, and efficient utilization of knowledge through database creation. Specific application fields include evaluation of talk quality in customer service, operator guidance in call centers, automatic classification of sales talks, emotion analysis of medical interview content, and automatic tagging of meeting minutes.

The visualization unit may comprise a display unit configured to highlight keywords or emphasize important phrases. Keyword highlighting may include, for example, changing colors or fonts, but is not limited to such examples. For example, keywords can be visually emphasized by displaying them in red. Keywords can also be visually emphasized by making them bold. Emphasizing important phrases may include, for example, bold or underline, but is not limited to such examples. For example, important phrases can be visually emphasized by displaying them in bold. Important phrases can also be visually emphasized by underlining them. This enables visual emphasis of important points in the talk, making them easier to understand. Some or all of the above-described processing in the display unit may be performed using AI or without using AI. For example, the display unit may input the content of the talk into generative AI and have the generative AI perform keyword highlighting or important phrase emphasis. Specifically, the display unit takes talk analysis data received from the analysis unit (e.g., important keyword list, important phrase list, importance score for each phrase) as input and automatically generates markup such as HTML/CSS or SVG for display modules such as web UI or digital signage. In keyword highlighting processing, the display unit identifies the occurrence positions of important keywords in the text and assigns attributes such as font color (e.g., #FF0000), font weight (bold), and background color (e.g., #FFFF00) to the corresponding parts. In important phrase emphasis, the display unit applies bold, underline, border, animation effects, etc. to the extracted phrases. When using AI, the display unit receives the full talk text and importance score array (e.g., 0.0-1.0 score for each phrase) as input and uses Transformer-based large language models or sequence labeling models (e.g., BiLSTM-CRF) to automatically determine the highlight target range and degree of emphasis. Examples of AI input include the full talk text, important keyword list, and importance score array. Examples of AI output include highlight target index arrays (e.g., [(12,18), (45,52)]), emphasis attribute lists (e.g., {‘color’:‘red’, ‘weight’:‘bold’}), and text with HTML tags. In subsequent processing, the generated emphasis data is output to web UI, printed materials, digital signage, etc., allowing users to grasp key points at a glance. Unlike conventional manual emphasis or simple keyword search, the display unit achieves context-dependent importance estimation and automatic layout optimization using AI, greatly improving visibility, comprehension, and educational effectiveness. Technical effects include immediate grasp of key points, improved learning efficiency through visual emphasis, reduction of misrecognition and oversight, and realization of interactive information presentation. Specific application fields include automatic generation of customer service training materials, emphasis of key points in meeting minutes, quality management of sales talks, emphasis of important items in medical records, and automatic generation of FAQs for customer support.

The imaging unit may be configured to estimate a user's emotion and adjust the timing of capturing based on the estimated emotion of the user. For example, if the user is relaxed, the imaging unit adjusts the timing of capturing to capture natural facial expressions and actions. If the user is nervous, the imaging unit may wait until the user relaxes before starting to capture. Furthermore, if the user is excited, the imaging unit may start capturing immediately to capture that emotion. This enables capturing at the optimal timing according to the user's emotion. Emotion estimation may be realized using an emotion engine or generative AI, among other emotion estimation functions. Generative AI may be a text generation AI (e.g., LLM) or multimodal generative AI, but is not limited to such examples. Some or all of the above-described processing in the imaging unit may be performed using AI or without using AI. For example, the imaging unit may input the user's facial expression data into generative AI and have the generative AI perform emotion estimation. Specifically, the imaging unit acquires multimodal input data such as the user's facial images, audio data, and posture information, preprocesses them as high-dimensional tensors (e.g., facial image 1920×1080×3, audio waveform float array of length 160,000, skeleton coordinate array), and inputs them into a multimodal emotion estimation model based on convolutional neural networks (CNN) or Transformer with self-attention mechanism. Examples of AI input include a facial image tensor, a 10-second audio waveform array, and a 3D skeleton coordinate sequence (e.g., 30 frames of 17 joints ×3 dimensions). The emotion estimation model comprises image feature extraction layers, acoustic feature extraction layers, and time-series integration layers, integrates features from each modality, and outputs emotion labels (e.g., relaxed, nervous, excited) and emotion scores (e.g., relaxed: 0.85, nervous: 0.10, excited: 0.05). Examples of AI output include emotion labels (relaxed), emotion score vectors ([0.85, 0.10, 0.05]), and estimation confidence (0.92). The imaging unit inputs these output values into a threshold judgment logic, and, for example, if the relaxed score is 0.8 or higher, immediate capturing is performed; if the nervous score is 0.5 or higher, a certain waiting period is applied; if the excited score is 0.7 or higher, burst mode capturing is started, etc., automatically controlling the capturing timing based on predefined rules. In subsequent processing, the capturing timing determination signal is transmitted to the camera control module, and actual shutter control or recording start/stop is performed. Unlike conventional subjective judgment by human operators or simple timer control, the imaging unit achieves dynamic control based on emotion estimation in high-dimensional feature space using AI, thereby optimizing capturing timing, enabling high-precision capture of natural expressions and actions, improving user experience, and reducing capturing failure rate. Specific application fields include educational video capturing for customer service, patient interview recording in medical settings, subject observation in psychological experiments, natural performance recording in entertainment, and automatic recording of remote meetings.

The imaging unit may use a high-resolution camera during capturing to record crew actions or facial expressions in detail. High-resolution cameras may include, for example, resolution or frame rate, but are not limited to such examples. For example, by using a high-resolution camera, subtle changes in crew facial expressions can be captured. A high-resolution camera can also be used to record crew gestures or body language in detail. Furthermore, a high-resolution camera can be used to smoothly capture crew actions. This enables detailed recording of subtle crew facial expressions and actions. Some or all of the above-described processing in the high-resolution camera may be performed using AI or without using AI. For example, the imaging unit may input video data obtained with a high-resolution camera into generative AI and have the generative AI analyze the video data. Specifically, the imaging unit may use high-resolution cameras such as 4K (3840×2160 pixels) or 8K (7680×4320 pixels) to perform continuous capturing at high frame rates of 60 frames per second or more. The imaging unit stores the video data obtained during capturing as RGB image tensors (e.g., 600 frames for 10 seconds, each frame 3840×2160×3 float array). The imaging unit preprocesses these high-resolution video data, applies noise removal, color correction, and automatic detection of facial regions or hand positions (e.g., object detection algorithms such as YOLOv5 or OpenPose). The imaging unit inputs the preprocessed video tensors into the analysis unit or AI module and uses video analysis models based on convolutional neural networks (CNN) or Transformer with self-attention mechanism to extract time-series patterns of facial expression changes, recognize gestures, and extract features of body language. Examples of AI input include facial region images for each frame (256×256×3), continuous frame tensors for 10 seconds (600×3840×2160×3), and time-series skeleton estimation results (e.g., 600 frames×17 joints×3D coordinates). Examples of AI output include facial expression change labels (e.g., smile, frown, surprise), gesture types (e.g., pointing, waving), action start/end timestamps, and action confidence scores (0.0-1.0). The imaging unit uses these outputs to automatically extract important expressions and actions, automatically cut out highlight segments, and automatically generate educational clips in subsequent processing. Unlike conventional visual confirmation by humans or simple video recording, the imaging unit analyzes high-resolution, high-frame-rate video with AI models to automatically detect and extract features of subtle expressions and actions, greatly improving recording accuracy, analysis accuracy, reproducibility, and educational effectiveness. Technical effects include quantitative evaluation of nonverbal communication by crew, immediate application to education and training, efficient knowledge sharing through video database creation, and reduced workload through automated video analysis. Specific application fields include educational video production for customer service, quality management of sales talks, patient observation recording in medical settings, behavioral analysis in psychological experiments, and form analysis in sports coaching.

The imaging unit may use multiple camera angles during capturing to comprehensively capture the overall scene of the talk from various perspectives. Multiple camera angles may include, for example, front, side, or top, but are not limited to such examples. For example, by using multiple cameras, the imaging unit can simultaneously capture video of the crew from the front, side, and back. The imaging unit can also capture crew actions or facial expressions from different angles using multiple cameras. Furthermore, the imaging unit can comprehensively record the overall scene of the talk using multiple cameras. This enables comprehensive capturing of the overall scene of the talk from various perspectives. Some or all of the above-described processing in multiple camera angles may be performed using AI or without using AI. For example, the imaging unit may input video data obtained from multiple cameras into generative AI and have the generative AI analyze the video data. Specifically, the imaging unit installs three or more high-resolution cameras at different angles (e.g., front, left and right sides, back, top) and simultaneously acquires video data from each camera. The imaging unit synchronously records the video from each camera with timestamps and stores it as video tensors (e.g., 600 frames for 10 seconds per camera, 3840×2160×3). The imaging unit preprocesses these multi-angle videos, performs time synchronization between cameras, spatial alignment (e.g., affine transformation by feature point matching), and feature extraction for each viewpoint. The imaging unit inputs the preprocessed multi-video tensors into multi-stream CNNs, 3D convolutional networks, or Transformer-based multimodal video analysis models to integratively extract action and facial expression features from each viewpoint. Examples of AI input include sets of video tensors from front, side, and back (3×600×3840×2160×3), time-series skeleton estimation results from each camera, and spatial position information between cameras. Examples of AI output include 3D reconstruction data of actions (e.g., 17 joints×3D×600 frames), facial expression change labels for each viewpoint, integrated labels of overall actions (e.g., standing, sitting, gesturing), and automatic extraction indices of important action segments. The imaging unit uses these outputs to perform subsequent processing such as 3D visualization of the overall scene, automatic generation of multi-viewpoint video, and automatic creation of educational multi-angle clips. Unlike conventional single-viewpoint video or manual editing by humans, the imaging unit integratively analyzes multi-angle video with AI models to achieve consistent overall scene understanding and feature extraction from multiple perspectives in both spatial and temporal dimensions, greatly improving recording accuracy, analysis accuracy, educational effectiveness, and video editing efficiency. Technical effects include comprehensive understanding of the entire talk, three-dimensional analysis of actions and facial expressions, immediate application to education and quality management, efficient knowledge sharing through video database creation, and automation of video editing tasks. Specific application fields include multi-viewpoint educational video production for customer service, three-dimensional analysis of sales talks, patient observation recording in medical settings, multi-viewpoint behavioral analysis in psychological experiments, and form analysis in sports coaching.

The imaging unit may be configured to estimate a user's emotion and determine the priority of scenes to be captured based on the estimated emotion of the user. For example, if the user is relaxed, the imaging unit prioritizes capturing natural scenes. If the user is nervous, the imaging unit may prioritize capturing scenes that induce relaxation. Furthermore, if the user is excited, the imaging unit may prioritize capturing scenes that reflect that emotion. This enables the imaging unit to prioritize capturing the optimal scenes according to the user's emotion. Emotion estimation may be realized using an emotion engine or generative AI, among other emotion estimation functions. Generative AI may be a text generation AI (e.g., LLM) or multimodal generative AI, but is not limited to such examples. Some or all of the above-described processing in the imaging unit may be performed using AI or without using AI. For example, the imaging unit may input the user's facial expression data into generative AI and have the generative AI perform emotion estimation. Specifically, the imaging unit simultaneously acquires multimodal data such as the user's facial images, audio waveforms, and posture information from high-resolution cameras, microphones, and motion sensors, preprocesses them as high-dimensional tensors (e.g., facial image 1920×1080×3, audio waveform float array of length 160,000, skeleton coordinate array), and inputs them into a multimodal emotion estimation model based on convolutional neural networks (CNN), recurrent neural networks (LSTM), and Transformer with self-attention mechanism. Examples of AI input include a facial image tensor, a 10-second audio waveform array, and a 3D skeleton coordinate sequence for 30 frames (17 joints×3 dimensions). Examples of AI output include emotion labels (relaxed), emotion score vectors ([0.85, 0.10, 0.05]), and estimation confidence (0.92). The imaging unit inputs these output values into a threshold judgment logic, and, for example, if the relaxed score is 0.8 or higher, natural scenes are prioritized; if the nervous score is 0.5 or higher, relaxation-inducing scenes are prioritized; if the excited score is 0.7 or higher, emotion-expressing scenes are prioritized, etc., automatically determining the priority of scenes to be captured based on predefined rules. In subsequent processing, the priority determination signal is transmitted to the camera control module or scene selection module, and actual scene selection or camera angle switching is performed. Unlike conventional subjective judgment by human operators or simple scenario selection, the imaging unit achieves dynamic scene control based on emotion estimation in high-dimensional feature space using AI, thereby optimizing scene selection, enabling high-precision capture of natural expressions and actions, improving user experience, and reducing capturing failure rate. Specific application fields include educational video capturing for customer service, patient interview recording in medical settings, subject observation in psychological experiments, natural performance recording in entertainment, and automatic recording of remote meetings.

The imaging unit may be configured to select an optimal capturing environment during capturing by considering crew background sounds or environmental sounds. Background sounds or environmental sounds may include, for example, noise level or sound source position, but are not limited to such examples. For example, the imaging unit may select a quiet environment with little background noise for capturing. The imaging unit may also select a location with moderate environmental sounds to create a natural atmosphere. Furthermore, the imaging unit may consider background sounds or environmental sounds to optimize microphone settings. This enables the imaging unit to select the optimal capturing environment by considering background sounds or environmental sounds. Some or all of the above-described processing in the imaging unit may be performed using AI or without using AI. For example, the imaging unit may input background sound or environmental sound data into generative AI and have the generative AI select the optimal capturing environment. Specifically, the imaging unit uses multiple high-sensitivity microphones and environmental sensors to acquire acoustic data of the capturing site (e.g., one-dimensional float array sampled at 16 kHz, 160,000 samples for 10 seconds) and environmental noise profiles (e.g., frequency spectrum, sound source direction vector) in real time. The imaging unit decomposes these acoustic data into frequency components using FFT (Fast Fourier Transform) or spectrogram transformation and inputs them into AI models (e.g., convolutional neural networks or self-attention-based acoustic classification models). Examples of AI input include a 10-second environmental sound waveform, a 256×256 spectrogram image, and sound source direction data from multiple microphones. Examples of AI output include noise level labels (e.g., quiet, moderate, noisy), sound source position estimation (e.g., 3 m behind left), optimal microphone setting parameters (e.g., directivity, sensitivity), and recommended capturing environment labels (e.g., quiet room, outdoors, café). The imaging unit uses these outputs to automatically select the optimal capturing location, automatically adjust microphone settings (e.g., apply noise reduction filter, switch to directional microphone), and automatically optimize the capturing schedule in subsequent processing. Unlike conventional site confirmation by humans or environment selection based on experience, the imaging unit achieves environment optimization based on high-dimensional acoustic feature analysis using AI, thereby stabilizing capturing quality, improving speech recognition accuracy, streamlining preparation work, and enhancing site adaptability. Specific application fields include educational video production for customer service, call center call recording, medical interview recording, lecture recording, and video production in noisy environments.

The imaging unit may use motion capture technology during capturing to analyze crew gestures or body language. Motion capture technology may include, for example, optical or inertial methods, but is not limited to such examples. For example, by using motion capture technology, the imaging unit can record crew gestures in detail. The imaging unit can also analyze crew body language using motion capture technology. Furthermore, the imaging unit can accurately capture crew actions using motion capture technology. This enables detailed analysis of crew gestures and body language. Some or all of the above-described processing in motion capture technology may be performed using AI or without using AI. For example, the imaging unit may input data obtained by motion capture technology into generative AI and have the generative AI analyze gestures or body language. Specifically, the imaging unit uses optical motion capture (e.g., marker tracking by multiple cameras) or inertial motion capture (e.g., IMU sensor-equipped suits) to acquire high-precision 3D coordinate data of all 17 crew joints (e.g., 600 frames×17 joints×3 dimensions). The imaging unit preprocesses these time-series skeleton data, performs noise removal, coordinate normalization, and automatic segmentation of action intervals. The imaging unit inputs the preprocessed skeleton data into recurrent neural networks (LSTM), graph neural networks (GCN), or Transformer-based time-series action recognition models to output gesture types (e.g., pointing, waving, nodding), body language features (e.g., openness, tension), and action start/end timestamps. Examples of AI input include skeleton coordinate arrays for 600 frames, time-series joint angle data, and action interval labeled data. Examples of AI output include gesture label arrays (e.g., [‘pointing’, ‘waving’, ‘nodding’]), body language scores (e.g., openness: 0.75, tension: 0.20), and action confidence scores (0.0-1.0). The imaging unit uses these outputs to automatically extract important gestures, automatically generate educational action clips, and quantitatively evaluate nonverbal communication in subsequent processing. Unlike conventional visual evaluation by humans or simple video recording, the imaging unit combines high-precision motion capture and AI-based time-series action analysis to achieve automatic recognition, feature extraction, and quantitative evaluation of gestures and body language, greatly expanding applications in education, quality management, and behavioral science research. Technical effects include objective evaluation of nonverbal communication, immediate application to education and training, efficient knowledge sharing through action database creation, and reduced workload through automated action analysis. Specific application fields include educational video production for customer service, quality management of sales talks, patient observation recording in medical settings, behavioral analysis in psychological experiments, and form analysis in sports coaching.

The transcription unit may be configured to estimate a user's emotion and adjust the accuracy of transcription based on the estimated emotion of the user. For example, if the user is relaxed, the transcription unit performs transcription with normal accuracy. If the user is nervous, the transcription unit may perform transcription with higher accuracy. Furthermore, if the user is excited, the transcription unit may perform transcription that reflects the emotion. This enables the transcription unit to adjust the accuracy of transcription according to the user's emotion. Emotion estimation may be realized using an emotion engine or generative AI, among other emotion estimation functions. Generative AI may be a text generation AI (e.g., LLM) or multimodal generative AI, but is not limited to such examples. Some or all of the above-described processing in the transcription unit may be performed using AI or without using AI. For example, the transcription unit may input the user's audio data into generative AI and have the generative AI perform emotion estimation. Specifically, the transcription unit simultaneously acquires multimodal data such as the user's audio data (e.g., one-dimensional float array sampled at 16 kHz, length 160,000 samples), facial image (1920×1080×3 RGB tensor), and posture information (skeleton coordinate array for 30 frames), preprocesses them for noise removal and normalization, and inputs them into a multimodal emotion estimation model based on convolutional neural networks (CNN), recurrent neural networks (LSTM), and Transformer with self-attention mechanism. Examples of AI input include a 10-second audio waveform array, a facial image tensor, and a skeleton coordinate sequence for 30 frames. Examples of AI output include emotion labels (relaxed), emotion score vectors ([0.80, 0.15, 0.05]), and estimation confidence (0.93). The transcription unit uses these emotion estimation results in the transcription accuracy control module, and, for example, if the relaxed score is 0.7 or higher, transcription is performed with normal acoustic and language model parameters; if the nervous score is 0.5 or higher, the beam search width of the acoustic model is expanded and noise-robust models or specialized vocabulary dictionaries are additionally applied to reduce misrecognition. If the excited score is 0.7 or higher, an emotion-labeled speech recognition model or emotion tagging function is enabled to reflect emotional expression, and emotion annotations (e.g., “(excitedly) The new product has arrived!”) are added to the utterance content. Examples of AI input for transcription include noise-removed audio waveform, emotion score vector, and confidence score for each utterance segment; examples of output include transcription text (UTF-8 string), emotion-annotated text, and accuracy score for each utterance. In subsequent processing, the accuracy-adjusted transcription results are passed to the analysis unit and used for important point extraction, summary generation, and registration in educational databases. Unlike conventional uniform speech recognition processing or subjective accuracy adjustment by humans, the transcription unit combines emotion estimation in high-dimensional feature space using AI and dynamic recognition parameter control to achieve optimal transcription accuracy and expressiveness according to recording environment and user state. Technical effects include improved transcription accuracy, automatic reflection of emotional nuances, reduced misrecognition rate, immediate application to education and quality management, and efficient recording and analysis of emotional changes. Specific application fields include educational records for customer service, transcription of patient interviews in medical settings, emotional utterance recording in psychological experiments, automatic generation of emotion-annotated meeting minutes, and operator evaluation in call centers.

The transcription unit may be configured to automatically recognize and accurately transcribe technical terms or industry-specific terminology during transcription. Technical terms or industry-specific terminology may include, for example, term dictionaries or machine learning models, but are not limited to such examples. For example, the transcription unit can automatically recognize and accurately transcribe technical terms. The transcription unit can also automatically recognize and accurately transcribe industry-specific terminology. Furthermore, the transcription unit can register technical terms or industry-specific terminology in a dictionary to improve transcription accuracy. This enables accurate transcription of technical terms or industry-specific terminology. Some or all of the above-described processing in the transcription unit may be performed using AI or without using AI. For example, the transcription unit may input data of technical terms or industry-specific terminology into generative AI and have the generative AI perform recognition and transcription. Specifically, the transcription unit takes audio data (e.g., one-dimensional float array sampled at 16 kHz, length 160,000 samples) as input, first extracts acoustic features (MFCC, spectrogram, etc.), and uses convolutional neural networks (CNN) or Transformer-based speech recognition models to generate text sequences from audio. The transcription unit applies custom dictionaries of technical terms and industry-specific terminology (e.g., medical term dictionary, IT term dictionary, sales term dictionary) to the generated text sequence and performs word-level matching and replacement. Examples of AI input include audio waveform array, technical term dictionary data (e.g., JSON format term list), and frequency statistics of industry-specific terminology. Examples of AI output include transcription text accurately reflecting technical terms, technical term recognition-labeled text (e.g., “CT scan,” “cloud service”), and candidate list of new terms. The transcription unit also has a function to automatically extract unknown words or misrecognized words from transcription results and automatically register or update them in the technical term dictionary based on user feedback or training data. Furthermore, the transcription unit manages different term sets for each industry as profiles and automatically selects the optimal dictionary set according to the talk content or speaker attributes. In subsequent processing, transcription results accurately reflecting technical terms are used for keyword extraction, summary generation, educational material creation, and quality management report generation in the analysis unit. Unlike conventional general speech recognition models or manual correction by humans, the transcription unit combines technical term recognition, automatic dictionary expansion, and industry-adaptive processing using AI to achieve high-accuracy transcription even in highly specialized environments or environments where new terms frequently appear. Technical effects include improved technical term recognition accuracy, automation of dictionary maintenance, improved cross-industry adaptability, immediate application to education and quality management, and enhanced ability to handle unknown terms. Specific application fields include transcription of medical records in medical settings, technical meeting minutes in the IT industry, automatic recording of sales talks, testimony records in the legal field, and industry-specific response records in call centers.

The transcription unit may be configured to adjust the timing of transcription according to the speed or rhythm of the talk during transcription. Speed or rhythm of the talk may include, for example, audio analysis or timing adjustment, but are not limited to such examples. For example, the transcription unit can adjust the timing of transcription according to the speed of the talk. The transcription unit can also adjust the timing of transcription according to the rhythm of the talk. Furthermore, the transcription unit can analyze the speed or rhythm of the talk and perform transcription at the optimal timing. This enables transcription at the optimal timing according to the speed or rhythm of the talk. Some or all of the above-described processing in the transcription unit may be performed using AI or without using AI. For example, the transcription unit may input audio data of the talk into generative AI and have the generative AI perform speed or rhythm analysis and timing adjustment. Specifically, the transcription unit takes audio data (e.g., one-dimensional float array sampled at 16 kHz, length 160,000 samples) as input, first extracts acoustic features (zero-crossing rate, spectral flux, energy envelope, etc.), and uses recurrent neural networks (LSTM) or Transformer-based time-series analysis models to estimate speech speed (e.g., number of phonemes per second), rhythm patterns (e.g., periodicity of strong and weak accents), and pause intervals (length of silent intervals). Examples of AI input include a 10-second audio waveform array, spectrogram image, and utterance interval labeled data. Examples of AI output include speech speed score (e.g., 3.2 phonemes/sec), rhythm pattern label (e.g., constant, accelerating, decelerating), and pause interval list (e.g., [(1.2 s, 1.5 s), (3.8 s , 4.0 s)]). The transcription unit uses these output values in the transcription timing control module, prioritizes real-time processing and performs sequential transcription with short windows when speech speed is fast, and detects pause intervals to optimize sentence segmentation when rhythm is irregular. Furthermore, the transcription unit dynamically adjusts acoustic model parameters (e.g., window size, overlap rate) and language model context length according to changes in speed or rhythm. In subsequent processing, timing-optimized transcription results are used for summary generation, real-time display, and educational feedback in the analysis unit. Unlike conventional uniform window segmentation or manual timing adjustment by humans, the transcription unit combines high-dimensional acoustic feature analysis and dynamic timing control using AI to achieve high-accuracy, high-real-time transcription that flexibly adapts to speaker characteristics and situational changes. Technical effects include improved real-time performance, reduced misrecognition rate, adaptation to speaker characteristics, immediate application to education and quality management, and efficient communication evaluation through speech rhythm analysis. Specific application fields include real-time generation of meeting minutes, automatic transcription of lecture recordings, response records in call centers, medical interview records, and timing analysis of sales talks.

The transcription unit may be configured to estimate a user's emotion and determine the priority of transcription based on the estimated emotion of the user. For example, if the user is relaxed, the transcription unit performs transcription with normal priority. If the user is nervous, the transcription unit may prioritize transcription of important parts. Furthermore, if the user is excited, the transcription unit may prioritize transcription of parts reflecting the emotion. This enables the transcription unit to perform transcription with optimal priority according to the user's emotion. Emotion estimation may be realized using an emotion engine or generative AI, among other emotion estimation functions. Generative AI may be a text generation AI (e.g., LLM) or multimodal generative AI, but is not limited to such examples. Some or all of the above-described processing in the transcription unit may be performed using AI or without using AI. For example, the transcription unit may input the user's audio data into generative AI and have the generative AI perform emotion estimation. Specifically, the transcription unit simultaneously acquires multimodal data such as the user's audio data (e.g., one-dimensional float array sampled at 16 kHz, length 160,000 samples), facial image (1920×1080×3 RGB tensor), and posture information (skeleton coordinate array for 30 frames), and inputs them into an emotion estimation model based on convolutional neural networks (CNN), recurrent neural networks (LSTM), and Transformer with self-attention mechanism. Examples of AI input include a 10-second audio waveform array, a facial image tensor, and a skeleton coordinate sequence for 30 frames. Examples of AI output include emotion labels (relaxed, nervous, excited), emotion score vectors ([0.70, 0.20, 0.10]), and estimation confidence (0.91). The transcription unit uses these emotion estimation results in the transcription priority control module, and if the relaxed score is 0.7 or higher, transcription is performed in the order of utterance as usual; if the nervous score is 0.5 or higher, segments containing important keywords or technical terms are prioritized for transcription. If the excited score is 0.7 or higher, segments with strong emotional expression (e.g., parts with large voice inflection, parts with sudden changes in speech speed) are automatically detected and prioritized for transcription and annotation. Examples of AI input for transcription include noise-removed audio waveform, emotion score vector, and confidence score for each utterance segment; examples of output include priority-labeled transcription text, text with important segment labels, and emotion-annotated text. In subsequent processing, priority-controlled transcription results are used for summary generation, educational feedback, and quality management report generation in the analysis unit. Unlike conventional uniform transcription order or subjective priority assignment by humans, the transcription unit combines emotion estimation in high-dimensional feature space using AI and dynamic priority control to achieve optimal transcription order and content according to user state and site conditions. Technical effects include rapid identification of important segments, immediate reflection of emotional changes, immediate application to education and quality management, and efficient recording of emotion-annotated records. Specific application fields include educational records for customer service, transcription of patient interviews in medical settings, emotional utterance recording in psychological experiments, automatic generation of emotion-annotated meeting minutes, and operator evaluation in call centers.

The transcription unit may be configured to add a function to automatically translate into multiple languages during transcription. Multiple languages may include, for example, machine translation or bilingual dictionaries, but are not limited to such examples. For example, the transcription unit can automatically translate into multiple languages simultaneously with transcription. The transcription unit can also automatically translate into multiple languages after transcription. Furthermore, the transcription unit can automatically translate into a language selected by the user during transcription. This enables automatic translation into multiple languages. Some or all of the above-described processing in the transcription unit may be performed using AI or without using AI. For example, the transcription unit may input transcription data into generative AI and have the generative AI perform translation into multiple languages. Specifically, the transcription unit takes audio data (e.g., one-dimensional float array sampled at 16 kHz, length 160,000 samples) as input, extracts acoustic features and uses a speech recognition model (e.g., Transformer-based multilingual speech recognition model) to first generate transcription text in the original language (e.g., Japanese). The transcription unit inputs the generated text into a neural machine translation model (e.g., Transformer-based encoder-decoder model, multilingual BERT, etc.) and automatically translates it into specified multiple languages (e.g., English, Chinese, Spanish). Examples of AI input include transcription text (Japanese), target language list ([‘en’, ‘zh’, ‘es’]), and contextual information (conversation history). Examples of AI output include translation text for each language (e.g., English “Welcome, how can I help you today?”, Chinese “ [symbol] [symbol] ?”), translation confidence score (e.g., 0.95), and error detection label for each language pair. The transcription unit automatically switches translation models and dictionary sets according to the language selected by the user or the language profile used on site, and applies custom dictionaries to accurately translate technical terms and industry-specific terminology. Furthermore, in real-time translation mode, speech recognition and translation are sequentially linked to achieve immediate multilingual display for each utterance. In subsequent processing, multilingual translation results are used for multilingual display in the visualization unit, automatic generation of educational materials, and real-time subtitle display at international conferences. Unlike conventional manual translation or single-language speech recognition, the transcription unit combines multilingual speech recognition, machine translation, and technical term dictionary linkage using AI to achieve high-accuracy, high-efficiency multilingual transcription and translation even in global sites or multinational teams. Technical effects include improved multilingual adaptability, realization of real-time translation, improved translation accuracy of technical terms, immediate application to education and international conferences, and significant reduction of translation workload. Specific application fields include real-time subtitles for international conferences, meeting records for global companies, multilingual interview records in medical settings, automatic generation of multilingual teaching materials in educational settings, and multilingual response records in call centers.

The transcription unit may be configured to remove background sounds or noise during transcription to generate clear audio data. Background sounds or noise may include, for example, noise filtering or echo canceling, but are not limited to such examples. For example, the transcription unit can remove background sounds to generate clear audio data. The transcription unit can also remove noise to generate clear audio data. Furthermore, the transcription unit can analyze background sounds or noise and perform optimal filtering. This enables the transcription unit to remove background sounds or noise to generate clear audio data. Some or all of the above-described processing in the transcription unit may be performed using AI or without using AI. For example, the transcription unit may input audio data into generative AI and have the generative AI perform removal of background sounds or noise. Specifically, the transcription unit takes audio data (e.g., one-dimensional float array sampled at 16 kHz, length 160,000 samples) as input, first extracts frequency components using FFT (Fast Fourier Transform) or spectrogram transformation, and uses convolutional neural networks (CNN), autoregressive models (LSTM, GRU), or Transformer-based speech enhancement models to estimate noise masks and perform speech enhancement processing. Examples of AI input include noise-contaminated audio waveform, spectrogram image (256×256 two-dimensional float array), and environmental noise profile (e.g., air conditioning noise, non-speaker voices). Examples of AI output include noise-removed audio waveform, noise mask array (0.0-1.0), and SNR (signal-to-noise ratio) score for each audio segment. The transcription unit inputs noise-removed audio into the transcription model to reduce the misrecognition rate of the acoustic model. Furthermore, the transcription unit dynamically switches filtering parameters and AI model weights according to the type and intensity of environmental noise to adapt to various recording environments. In subsequent processing, clarified audio data is used for transcription text generation, summary and sentiment analysis in the analysis unit, and registration in educational databases. Unlike conventional simple band-pass filters or manual noise removal by humans, the transcription unit combines high-dimensional acoustic feature analysis and dynamic noise removal using AI to achieve optimal speech clarification and improved transcription accuracy according to recording environment and noise conditions. Technical effects include improved speech recognition accuracy, reduced misrecognition rate, adaptation to diverse recording environments, immediate application to education and quality management, and enhanced noise resistance. Specific application fields include call center call record analysis, meeting minutes creation, medical interview records, lecture recording in educational settings, and voice interfaces in noisy environments.

The analysis unit may be configured to estimate a user's emotion and adjust the analysis algorithm based on the estimated emotion of the user. For example, if the user is relaxed, the analysis unit performs analysis using a normal algorithm. If the user is nervous, the analysis unit may perform analysis using a more accurate algorithm. Furthermore, if the user is excited, the analysis unit may perform analysis using an algorithm that reflects the emotion. This enables the analysis unit to perform analysis using the optimal algorithm according to the user's emotion. Emotion estimation may be realized using an emotion engine or generative AI, among other emotion estimation functions. Generative AI may be a text generation AI (e.g., LLM) or multimodal generative AI, but is not limited to such examples. Some or all of the above-described processing in the analysis unit may be performed using AI or without using AI. For example, the analysis unit may input the user's emotion data into generative AI and have the generative AI adjust the algorithm. Specifically, the analysis unit receives the user's emotion estimation results (e.g., emotion label relaxed, nervous, excited and emotion score vector [0.75, 0.15, 0.10]) as input, and in the analysis algorithm selection module, dynamically switches parameters and model configurations for each stage of the analysis pipeline (e.g., keyword extraction, summary generation, sentiment analysis, topic classification). The analysis unit uses multimodal data such as facial image (1920×1080×3 RGB tensor), audio waveform (one-dimensional float array sampled at 16 kHz), and posture information (skeleton coordinate array for 30 frames) for emotion estimation, and performs estimation using convolutional neural networks (CNN), recurrent neural networks (LSTM), and Transformer-based emotion estimation models. Examples of AI input include a 10-second audio waveform array, a facial image tensor, and a skeleton coordinate sequence for 30 frames. Examples of AI output include emotion labels (relaxed), emotion score vectors ([0.75, 0.15, 0.10]), and estimation confidence (0.92). If the emotion score for relaxed is 0.7 or higher, the analysis unit applies normal Transformer-based large language model (LLM) algorithms for summary and keyword extraction; if the nervous score is 0.5 or higher, ensemble models or high-precision context-dependent classifiers (e.g., BERT+CRF) are additionally applied to reduce false detection, and threshold or confidence score lower limits are tightened. If the excited score is 0.7 or higher, emotion-labeled summary generation models or emotion change detection algorithms (e.g., peak detection of time-series emotion scores) are enabled to emphasize emotional expression, and emotion annotations (e.g., “(excitedly) The new product has arrived!”) are added to the analysis results. The analysis unit performs these algorithm switches in real time and optimizes the reliability and expressiveness of analysis results according to user state. In subsequent processing, the adjusted analysis results are passed to the visualization unit, educational database, and quality management report generation module. Unlike conventional uniform analysis algorithms or subjective parameter adjustment by humans, the analysis unit combines emotion estimation in high-dimensional feature space using AI and dynamic analysis pipeline control to achieve optimal analysis accuracy, expressiveness, and immediacy according to user state and site conditions. Technical effects include improved analysis accuracy, automatic reflection of emotional nuances, reduced false detection rate, immediate application to education and quality management, and efficient recording and analysis of emotional changes. Specific application fields include analysis of educational records for customer service, analysis of patient interviews in medical settings, emotional utterance analysis in psychological experiments, automatic analysis of emotion-annotated meeting minutes, and operator evaluation in call centers.

The analysis unit may be configured to extract important points by considering the context or background information of the talk during analysis. Context or background information may include, for example, text analysis or extraction of related information, but are not limited to such examples. For example, the analysis unit can analyze the context of the talk and extract important points. The analysis unit can also consider the background information of the talk to extract important points. Furthermore, the analysis unit can comprehensively analyze the context and background information of the talk to extract the most important points. This enables the analysis unit to extract important points by considering the context or background information of the talk. Some or all of the above-described processing in the analysis unit may be performed using AI or without using AI. For example, the analysis unit may input text data of the talk into generative AI and have the generative AI perform context or background information analysis and important point extraction. Specifically, the analysis unit receives the full talk text obtained from the transcription unit (e.g., several thousand characters of UTF-8 encoded text) as input, first performs morphological analysis and dependency parsing, and obtains context information (e.g., flow of conversation, speaker's intent, relationships before and after) and background information (e.g., product information, customer attributes, past conversation history) from external databases or knowledge graphs for integration. The analysis unit uses Transformer-based large language models (LLM) or sequence labeling models (e.g., BiLSTM-CRF) to perform context-dependent important phrase extraction, summary generation, and related information linking. Examples of AI input include the full talk text, related background information data (e.g., product description, customer profile), and conversation history data. Examples of AI output include important point lists (e.g., “product feature explanation,” “closing talk”), summary sentences (e.g., “This talk includes a new product feature explanation and closing”), and key points with related information links (e.g., “Features of product A are here”). The analysis unit combines context weighting using attention mechanisms, entity linking with external knowledge graphs, and similarity calculation with background information (e.g., cosine similarity) in the important point extraction algorithm to achieve key point extraction suited to the flow and purpose of the conversation, rather than simple keyword extraction. In subsequent processing, the extracted important points are used for graph display in the visualization unit, educational feedback, and quality management report generation. Unlike conventional simple keyword matching or subjective key point extraction by humans, the analysis unit achieves context and background information integration analysis in high-dimensional feature space using AI, greatly improving analysis accuracy, reproducibility, and application range. Technical effects include improved key point extraction accuracy, automatic linking of related information, immediate application to education and quality management, and efficient knowledge sharing. Specific application fields include evaluation of talk quality in customer service, key point extraction in sales talks, analysis of medical interview records, automatic summarization and tagging of meeting minutes, and analysis of response records in call centers.

The analysis unit can analyze the content of a talk in real time and provide results immediately during analysis. Real-time analysis may include, for example, streaming analysis or real-time data processing, but is not limited thereto. For example, the analysis unit can analyze the content of a talk in real time and provide results immediately. Additionally, the analysis unit can analyze the content of a talk in real time and immediately display important points. Furthermore, the analysis unit can analyze the content of a talk in real time and immediately visualize the results. As a result, the content of a talk can be analyzed in real time and results can be provided immediately. Some or all of the above-described processing in the analysis unit may be performed using AI, or may be performed without using AI. For example, the analysis unit can input streaming data of a talk into generative AI and have the generative AI perform real-time analysis and result provision. Specifically, the analysis unit receives streaming data (e.g., arrays of audio waveforms every second, real-time generated text fragments) sequentially from the audio processing unit or transcription unit as input, and performs analysis in batches or windows on a stream processing engine. The analysis unit uses Transformer-based large language models (LLMs) or time-series analysis models (e.g., LSTM, GRU) to perform sequential keyword extraction, summary generation, sentiment analysis, and topic classification in real time. Examples of input to AI include arrays of audio waveforms every second, real-time generated text fragments, and confidence scores for each utterance segment. Examples of output from AI include immediately updated lists of important points (e.g., [‘greeting’, ‘product explanation’]), real-time summary sentences (e.g., ‘Currently explaining product features’), emotion scores (e.g., 0.85), and topic labels (e.g., ‘closing’). The analysis unit immediately transmits analysis results to the visualization unit or user interface via interfaces such as WebSocket or REST API, and updates graphs, charts, and highlight displays in real time. Furthermore, to minimize streaming data latency, the analysis unit performs optimizations such as model lightweighting (e.g., use of distilled models), parallel inference using GPUs, and dynamic adjustment of batch size. As post-processing, real-time analysis results are immediately utilized for educational feedback, quality management reports, and on-site operation support. Unlike conventional batch processing analysis or manual post-processing, the analysis unit combines real-time inference in high-dimensional feature space by AI with stream data processing, greatly improving immediacy, accuracy, and on-site adaptability. Technical effects include improved real-time performance, realization of immediate feedback, immediate application to education and quality management, and increased efficiency of on-site operations. Specific application fields include real-time generation of meeting minutes, analysis of call center response records, medical interview records, immediate evaluation of sales talks, and lecture feedback in educational settings.

The analysis unit can estimate a user's emotion and adjust the display method of analysis results based on the estimated emotion. For example, the analysis unit provides analysis results using a normal display method when the user is relaxed. Additionally, the analysis unit can provide analysis results using a highly visible display method when the user is nervous. Furthermore, the analysis unit can provide analysis results using a display method that reflects emotion when the user is excited. Thus, the analysis unit can provide analysis results using the optimal display method according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the analysis unit may be performed using AI, or may be performed without using AI. For example, the analysis unit can input user emotion data into generative AI and have the generative AI perform adjustment of the display method. Specifically, the analysis unit receives user emotion estimation results (e.g., emotion labels such as relaxed, nervous, excited and emotion score vectors [0.80, 0.10, 0.10]) as input, and dynamically switches the display format of analysis results (e.g., color, font size, emphasis level, animation effects) and information granularity (e.g., summary level, detail level) in the display method control module. The analysis unit uses multimodal data such as facial images, audio waveforms, and posture information for emotion estimation, and performs estimation using convolutional neural networks (CNN), recurrent neural networks (LSTM), and Transformer-based emotion estimation models. Examples of input to AI include arrays of audio waveforms for 10 seconds, one facial image tensor, and 30 frames of skeletal coordinate sequences. Examples of output from AI include emotion labels (relaxed), emotion score vectors ([0.80, 0.10, 0.10]), and estimation confidence (0.93). The analysis unit displays analysis results using standard graphs or charts and normal colors and fonts when the relaxed score is 0.7 or higher, applies high-contrast colors, large fonts, and highlight display of important points to improve visibility when the nervous score is 0.5 or higher, and uses animation effects and emotional colors (e.g., red, yellow) and generates summary sentences or graphs with emotion annotations to emphasize emotional expression when the excited score is 0.7 or higher. The analysis unit executes these display method switches in real time to provide optimal information presentation according to the user's state and usage scene. As post-processing, the adjusted display results are passed to the visualization unit, user interface, and educational material generation module. Unlike conventional uniform display formats or manual adjustment by humans, the analysis unit combines emotion estimation in high-dimensional feature space by AI with dynamic display control, greatly improving user experience, comprehension, and educational effectiveness. Technical effects include improved visibility and comprehension, automatic reflection of emotional nuances, immediate application to education and quality management, and realization of interactive information presentation. Specific application fields include generation of educational materials for customer service, display of analysis results for patient interviews in medical settings, visualization of emotional changes in psychological experiments, display of minutes with emotion annotations, and evaluation of call center operators.

The analysis unit can classify and organize the content of a talk by category during analysis. Classification by category may include, for example, classification by topic or importance, but is not limited thereto. For example, the analysis unit can classify and organize the content of a talk by category. Additionally, the analysis unit can classify and organize the content of a talk by theme. Furthermore, the analysis unit can classify the content of a talk by category and extract important points. Thus, the analysis unit can classify and organize the content of a talk by category. Some or all of the above-described processing in the analysis unit may be performed using AI, or may be performed without using AI. For example, the analysis unit can input talk text data into generative AI and have the generative AI perform classification and organization by category. Specifically, the analysis unit receives the full text of the talk obtained from the transcription unit (e.g., UTF-8 encoded text of several thousand characters) as input, first performs morphological analysis and part-of-speech tagging, and generates feature vectors (e.g., BERT embedding vectors, dimension 768) for each sentence or utterance. The analysis unit uses a pre-trained supervised multi-class classification model (e.g., Transformer-based text classifier, SVM, random forest, etc.) to classify each utterance or sentence into predefined categories such as ‘product explanation’, ‘closing’, ‘greeting’, or by importance (e.g., high, medium, low). Examples of input to AI include the full text of the talk, arrays of text by sentence, and category definition lists. Examples of output from AI include arrays of category labels for each sentence or utterance (e.g., [‘product explanation’, ‘closing’, ‘greeting’]), arrays of importance labels (e.g., [‘high’, ‘medium’, ‘low’]), and classification confidence scores (e.g., 0.85, 0.60, 0.95). Based on the classification results, the analysis unit organizes the content of the talk by category or theme and applies important point extraction algorithms (e.g., extraction of frequently occurring phrases within categories, extraction of top importance scores). As post-processing, the content of the talk organized by category is used for graph generation in the visualization unit, creation of educational materials, and generation of quality management reports. Unlike conventional subjective classification by humans or simple keyword matching, the analysis unit realizes pattern learning and context-dependent classification in high-dimensional feature space by AI, greatly improving classification accuracy, reproducibility, and processing speed. Technical effects include improved automatic classification accuracy of talk content, efficient extraction of important points, immediate application to education and quality management, and increased efficiency of knowledge sharing. Specific application fields include evaluation of talk quality in customer service, automatic classification of sales talks, organization of interview content in medical settings, automatic tagging of minutes, and analysis of call center response records.

The analysis unit can improve accuracy by matching the content of a talk with other related data during analysis. Other related data may include, for example, database matching or display of related information, but is not limited thereto. For example, the analysis unit can match the content of a talk with other related data to improve the accuracy of analysis. Additionally, the analysis unit can match the content of a talk with other related data and extract important points. Furthermore, the analysis unit can match the content of a talk with other related data and visualize the analysis results. Thus, the analysis unit can improve the accuracy of analysis by matching the content of a talk with other related data. Some or all of the above-described processing in the analysis unit may be performed using AI, or may be performed without using AI. For example, the analysis unit can input talk text data into generative AI and have the generative AI perform matching with other related data. Specifically, the analysis unit receives the full text of the talk obtained from the transcription unit (e.g., UTF-8 encoded text of several thousand characters) as input, retrieves related information from external databases (e.g., product information DB, FAQ knowledge base, past conversation history DB) or knowledge graphs. The analysis unit uses natural language processing algorithms (e.g., entity linking, similarity calculation, information retrieval models) and Transformer-based large language models (LLMs) to perform matching and comparison between the talk content and related data. Examples of input to AI include the full text of the talk, lists of entries in related databases, and past conversation history data. Examples of output from AI include lists of matching results with related data (e.g., matches with product A description, similarity to FAQ item B), lists of important points extracted by matching with related data, and analysis results with links to related information (e.g., summary with ‘see details here’ link). Based on the matching results, the analysis unit applies accuracy improvement algorithms (e.g., reliability correction based on degree of match with related data, generation of supplementary explanations using external knowledge) to enhance the reliability and comprehensiveness of analysis results. As post-processing, matched analysis results are used for display of related information links in the visualization unit, creation of educational materials, and generation of quality management reports. Unlike conventional standalone data analysis or manual matching by humans, the analysis unit realizes integrated analysis of related data in high-dimensional feature space by AI, greatly improving analysis accuracy, reproducibility, and application range. Technical effects include improved analysis accuracy, automatic linking of related information, immediate application to education and quality management, increased efficiency of knowledge sharing, and enhanced ability to handle unknown words and new events. Specific application fields include evaluation of talk quality in customer service, matching of related information in sales talks, analysis of interview records in medical settings, automatic summarization and tagging of minutes, and analysis of call center response records.

The visualization unit can estimate a user's emotion and adjust the visualization method based on the estimated emotion. For example, the visualization unit provides results using a normal visualization method when the user is relaxed. Additionally, the visualization unit can provide results using a highly visible visualization method when the user is nervous. Furthermore, the visualization unit can provide results using a visualization method that reflects emotion when the user is excited. Thus, the visualization unit can provide results using the optimal visualization method according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the visualization unit may be performed using AI, or may be performed without using AI. For example, the visualization unit can input user emotion data into generative AI and have the generative AI perform adjustment of the visualization method. Specifically, the visualization unit receives user emotion estimation results (e.g., emotion labels such as relaxed, nervous, excited and emotion score vectors [0.80, 0.10, 0.10]) as input, and dynamically switches display parameters such as graphs, charts, highlight display, color, font size, emphasis level, and animation effects in the visualization method control module. The visualization unit uses multimodal data such as facial images (1920×1080×3 RGB tensor), audio waveforms (16 kHz sampled 1D float array), and posture information (30 frames of skeletal coordinate array) for emotion estimation, and performs estimation using convolutional neural networks (CNN), recurrent neural networks (LSTM), and Transformer-based emotion estimation models with self-attention mechanisms. Examples of input to AI include arrays of audio waveforms for 10 seconds, one facial image tensor, and 30 frames of skeletal coordinate sequences. Examples of output from AI include emotion labels (relaxed), emotion score vectors ([0.80, 0.10, 0.10]), and estimation confidence (0.93). The visualization unit displays analysis results using standard graphs or charts and normal colors and fonts when the relaxed score is 0.7 or higher, applies high-contrast colors, large fonts, and highlight display of important points to improve visibility when the nervous score is 0.5 or higher, and uses animation effects and emotional colors (e.g., red, yellow) and generates summary sentences or graphs with emotion annotations to emphasize emotional expression when the excited score is 0.7 or higher. The visualization unit executes these visualization method switches in real time to provide optimal information presentation according to the user's state and usage scene. As post-processing, the adjusted display results are passed to the user interface and educational material generation module. Unlike conventional uniform display formats or manual adjustment by humans, the visualization unit combines emotion estimation in high-dimensional feature space by AI with dynamic display control, greatly improving user experience, comprehension, and educational effectiveness. Technical effects include improved visibility and comprehension, automatic reflection of emotional nuances, immediate application to education and quality management, and realization of interactive information presentation. Specific application fields include generation of educational materials for customer service, display of analysis results for patient interviews in medical settings, visualization of emotional changes in psychological experiments, display of minutes with emotion annotations, and evaluation of call center operators.

The visualization unit can visually display important points of a talk in graphs or charts during visualization. Graphs or charts may include, for example, bar graphs or pie charts, but are not limited thereto. For example, the visualization unit can visually display important points of a talk in graphs. Additionally, the visualization unit can visually display important points of a talk in charts. Furthermore, the visualization unit can visually display important points of a talk in graphs or charts and emphasize key points. Thus, by visually displaying important points of a talk, key points can be grasped at a glance. Some or all of the above-described processing in the visualization unit may be performed using AI, or may be performed without using AI. For example, the visualization unit can input talk analysis data into generative AI and have the generative AI generate graphs or charts. Specifically, the visualization unit receives talk analysis data (e.g., important keyword lists, important phrase lists, importance scores for each phrase) from the analysis unit as input, and automatically generates markup such as HTML/CSS or SVG for display modules such as web UI or digital signage. In graph generation processing, the visualization unit visualizes the frequency of occurrence and importance scores of important points in formats such as bar graphs, pie charts, or radar charts, and automatically applies color coding and emphasis to each element. When using AI, the visualization unit receives the full text of the talk and arrays of importance scores for each phrase (e.g., scores from 0.0 to 1.0 for each phrase) as input, and uses Transformer-based large language models or sequence labeling models (e.g., BiLSTM-CRF) to automatically determine the range and degree of emphasis for graph targets. Examples of input to AI include the full text of the talk, important keyword lists, and arrays of importance scores. Examples of output from AI include graph data structures (e.g., arrays of occurrence counts by category), chart data (e.g., time-series key point scores), and graph display data with HTML tags. As post-processing, the generated graphs or charts are output to web UI, printed materials, or digital signage, allowing users to grasp key points at a glance. Unlike conventional manual graph creation or simple keyword search, the visualization unit realizes context-dependent importance estimation and automatic layout optimization by AI, greatly improving visibility, comprehension, and educational effectiveness. Technical effects include immediate grasp of key points, improved learning efficiency through visual emphasis, reduction of misrecognition and oversight, and realization of interactive information presentation. Specific application fields include automatic generation of customer service training materials, emphasis of key points in minutes, quality management of sales talks, emphasis of important items in medical records, and automatic generation of FAQs for customer support.

The visualization unit can summarize and concisely display the content of a talk during visualization. Summarization and concise display may include, for example, summarization algorithms or display formats, but are not limited thereto. For example, the visualization unit can summarize and concisely display the content of a talk. Additionally, the visualization unit can summarize and concisely display important points of a talk. Furthermore, the visualization unit can summarize and visually display the content of a talk. Thus, by summarizing and concisely displaying the content of a talk, important points can be efficiently grasped. Some or all of the above-described processing in the visualization unit may be performed using AI, or may be performed without using AI. For example, the visualization unit can input talk analysis data into generative AI and have the generative AI perform summarization and display. Specifically, the visualization unit receives the full text of the talk and important point lists from the analysis unit as input, and uses summarization generation algorithms (e.g., Transformer-based large language models, extractive summarization models, generative summarization models) to concisely summarize the main points of the entire talk in several sentences or bullet points. Examples of input to AI include the full text of the talk (several thousand characters), important point lists, and conversation history data. Examples of output from AI include summary sentences (e.g., ‘This talk includes an explanation of new product features and closing’), bullet point lists of important points (e.g., ‘Product feature explanation’, ‘Closing talk’), and summary confidence scores (e.g., 0.92). The visualization unit automatically generates the summary results in HTML/CSS or text format for display modules such as web UI or digital signage, allowing users to grasp key points at a glance. Furthermore, by highlighting important keywords or phrases in the summary sentences, visual emphasis is also achieved. As post-processing, summary display is used for automatic generation of educational materials, emphasis of key points in minutes, and creation of quality management reports. Unlike conventional manual summarization or simple excerpt display, the visualization unit combines context-dependent summarization generation by AI with automatic layout optimization, greatly improving information compression rate, comprehension, and application range. Technical effects include efficient grasp of key points, rapid information transmission, immediate application to education and quality management, and increased efficiency of knowledge sharing. Specific application fields include generation of educational materials for customer service, summarization of sales talks, summarization of medical interview records, automatic summarization of minutes, and summarization of call center response records.

The visualization unit can estimate a user's emotion and determine the priority of visualization based on the estimated emotion. For example, the visualization unit performs visualization with normal priority when the user is relaxed. Additionally, the visualization unit can prioritize important points for visualization when the user is nervous. Furthermore, the visualization unit can prioritize points that reflect emotion for visualization when the user is excited. Thus, the visualization unit can perform visualization with the optimal priority according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the visualization unit may be performed using AI, or may be performed without using AI. For example, the visualization unit can input user emotion data into generative AI and have the generative AI determine the priority. Specifically, the visualization unit receives user emotion estimation results (e.g., emotion labels such as relaxed, nervous, excited and emotion score vectors [0.70, 0.20, 0.10]) as input, and dynamically switches the order and degree of emphasis of display items such as graphs, charts, highlight display, and summary display in the visualization priority control module. The visualization unit uses multimodal data such as facial images, audio waveforms, and posture information for emotion estimation, and performs estimation using convolutional neural networks (CNN), recurrent neural networks (LSTM), and Transformer-based emotion estimation models with self-attention mechanisms. Examples of input to AI include arrays of audio waveforms for 10 seconds, one facial image tensor, and 30 frames of skeletal coordinate sequences. Examples of output from AI include emotion labels (relaxed, nervous, excited), emotion score vectors ([0.70, 0.20, 0.10]), and estimation confidence (0.91). The visualization unit performs visualization in utterance order as usual when the relaxed score is 0.7 or higher, prioritizes display of sections containing important keywords or technical terms in graphs or highlights when the nervous score is 0.5 or higher, and automatically detects sections where emotional expression is strong (e.g., parts with large voice inflection, parts where speech rate changes rapidly) and prioritizes emphasis display when the excited score is 0.7 or higher. As post-processing, visualization results with controlled priority are used for user interfaces, generation of educational materials, and creation of quality management reports. Unlike conventional uniform display order or subjective prioritization by humans, the visualization unit combines emotion estimation in high-dimensional feature space by AI with dynamic priority control, realizing optimal visualization order and content according to user state and on-site conditions. Technical effects include rapid grasp of important sections, immediate reflection of emotional changes, immediate application to education and quality management, and increased efficiency of records with emotion annotations. Specific application fields include educational records for customer service, analysis of patient interview records in medical settings, recording of emotional utterances in psychological experiments, automatic generation of minutes with emotion annotations, and evaluation of call center operators.

The visualization unit can display the content of a talk in an interactive format during visualization. Interactive formats may include, for example, user interfaces or operation methods, but are not limited thereto. For example, the visualization unit can display the content of a talk in interactive graphs. Additionally, the visualization unit can display the content of a talk in interactive charts. Furthermore, the visualization unit can display the content of a talk in an interactive format, allowing users to check details. Thus, by displaying the content of a talk in an interactive format, users can check details. Some or all of the above-described processing in the visualization unit may be performed using AI, or may be performed without using AI. For example, the visualization unit can input talk analysis data into generative AI and have the generative AI perform display in an interactive format. Specifically, the visualization unit receives talk analysis data (e.g., important point lists, summary sentences, emotion scores) from the analysis unit as input, and automatically generates dynamic graphs or charts using HTML5, JavaScript, SVG, etc., for interactive display modules such as web UI or digital signage. In interactive display processing, the visualization unit enables users to click on graph elements to display detailed information in pop-ups, and allows operations such as filtering, sorting, zooming in and out. When using AI, the visualization unit receives the full text of the talk, important point lists, and user operation history as input, and dynamically optimizes display content and layout according to user interest and operation tendencies. Examples of input to AI include talk analysis data, user operation logs, and arrays of importance scores. Examples of output from AI include interactive graph structures (e.g., JSON with node and edge information), dynamic layout parameters, and display order optimized for each user. As post-processing, the generated interactive displays are used for web UI, educational materials, and quality management reports. Unlike conventional static graph displays or manual detail checking, the visualization unit combines user behavior analysis by AI with dynamic layout optimization, greatly improving user experience, comprehension, and educational effectiveness. Technical effects include improved information searchability, optimized display for each user, interactive learning support, and increased efficiency of on-site operations. Specific application fields include generation of educational materials for customer service, detailed analysis of sales talks, analysis of medical interview records, interactive display of minutes, and analysis of call center response records.

The visualization unit can display the content of a talk linked with other related information during visualization. Linking with other related information may include, for example, hyperlinks or display of related data, but is not limited thereto. For example, the visualization unit can display the content of a talk linked with other related information. Additionally, the visualization unit can link the content of a talk with other related information and emphasize important points. Furthermore, the visualization unit can link the content of a talk with other related information and display it visually. Thus, by displaying the content of a talk linked with other related information, the relevance of information can be visually grasped. Some or all of the above-described processing in the visualization unit may be performed using AI, or may be performed without using AI. For example, the visualization unit can input talk analysis data into generative AI and have the generative AI perform linking with related information. Specifically, the visualization unit receives the full text of the talk and important point lists from the analysis unit as input, retrieves related information from external databases (e.g., product information DB, FAQ knowledge base, past conversation history DB) or knowledge graphs, and automatically generates hyperlinks or displays related data. When using AI, the visualization unit receives the full text of the talk, lists of entries in related databases, and candidate lists for related information links as input, and uses natural language processing algorithms (e.g., entity linking, similarity calculation, information retrieval models) and Transformer-based large language models to perform matching and comparison between the talk content and related data. Examples of input to AI include the full text of the talk, related database entries, and candidate lists for related information links. Examples of output from AI include lists of key points with related information links (e.g., ‘See here for features of product A’), lists of matching results with related data, and HTML display data with links. The visualization unit automatically inserts related information links into web UI, educational materials, and quality management reports, allowing users to immediately refer to related information. Unlike conventional manual link assignment or standalone data display, the visualization unit combines integrated analysis of related data in high-dimensional feature space by AI with automatic link generation, greatly improving comprehensiveness, searchability, and application range of information. Technical effects include immediate reference to related information, increased efficiency of knowledge sharing, immediate application to education and quality management, and enhanced ability to handle unknown words and new events. Specific application fields include evaluation of talk quality in customer service, matching of related information in sales talks, analysis of medical interview records in medical settings, automatic summarization and tagging of minutes, and analysis of call center response records.

The audio processing unit can estimate a user's emotion and adjust audio processing filtering based on the estimated emotion. For example, the audio processing unit performs normal filtering for audio processing when the user is relaxed. Additionally, the audio processing unit can remove noise and provide clear audio when the user is nervous. Furthermore, the audio processing unit can perform audio processing that reflects emotion when the user is excited. Thus, the audio processing unit can perform audio processing with optimal filtering according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the audio processing unit may be performed using AI, or may be performed without using AI. For example, the audio processing unit can input user audio data into generative AI and have the generative AI perform adjustment of filtering. Specifically, the audio processing unit simultaneously acquires user audio data (e.g., 1D float array sampled at 16 kHz, length 160,000 samples), facial images (1920×1080×3 RGB tensor), and posture information (30 frames of skeletal coordinate array), preprocesses them for noise removal and normalization, and inputs them into a multimodal emotion estimation model based on convolutional neural networks (CNN), recurrent neural networks (LSTM), and Transformer with self-attention mechanisms to output emotion labels (e.g., relaxed, nervous, excited) and emotion scores (e.g., relaxed: 0.80, nervous: 0.15, excited: 0.05). Examples of input to AI include arrays of audio waveforms for 10 seconds, one facial image tensor, and 30 frames of skeletal coordinate sequences. Examples of output from AI include emotion labels (relaxed), emotion score vectors ([0.80, 0.15, 0.05]), and estimation confidence (0.93). Based on these emotion estimation results, the audio filtering control module executes standard noise reduction filters and equalizer settings for audio processing when the relaxed score is 0.7 or higher, increases noise suppression strength and applies spectral subtraction or autoregressive noise suppression models when the nervous score is 0.5 or higher, and applies acoustic effects that expand the dynamic range of audio and emphasize changes in pitch or formant to enhance emotional expression when the excited score is 0.7 or higher. Examples of input for AI-based audio processing include noisy audio waveforms, emotion score vectors, and confidence scores for each utterance segment; examples of output include filtered audio waveforms, emotion-enhanced audio, and lists of filter application parameters. As post-processing, filtered audio data is passed to the transcription unit or analysis unit, contributing to improved transcription accuracy and emotion analysis accuracy. Unlike conventional uniform audio filtering or subjective acoustic adjustment by humans, the audio processing unit combines emotion estimation in high-dimensional feature space by AI with dynamic filtering control, realizing optimal audio quality and emotional expressiveness according to user state and recording environment. Technical effects include improved speech recognition accuracy, automatic reflection of emotional nuances, reduced misrecognition rate, immediate application to education and quality management, and increased efficiency of recording and analysis of emotional changes. Specific application fields include analysis of call center call records, medical interview records in medical settings, lecture recordings in educational settings, automatic generation of minutes with emotion annotations, and educational records in customer service.

The audio processing unit can use noise canceling technology to remove background sounds during audio processing. Noise canceling technology may include, for example, active noise canceling or passive noise canceling, but is not limited thereto. For example, the audio processing unit can use noise canceling technology to remove background sounds. Additionally, the audio processing unit can use noise canceling technology to provide clear audio. Furthermore, the audio processing unit can use noise canceling technology to emphasize important audio. Thus, by using noise canceling technology to remove background sounds, clear audio can be provided. Some or all of the above-described processing in the audio processing unit may be performed using AI, or may be performed without using AI. For example, the audio processing unit can input audio data into generative AI and have the generative AI perform noise canceling. Specifically, the audio processing unit receives audio data (e.g., 1D float array sampled at 16 kHz, length 160,000 samples) as input, first extracts frequency components using FFT (Fast Fourier Transform) or spectrogram conversion, and uses convolutional neural networks (CNN), autoregressive models (LSTM, GRU), or Transformer-based audio enhancement models to estimate noise masks and perform audio enhancement processing. Examples of input to AI include noisy audio waveforms, spectrogram images (256×256 2D float array), and environmental noise profiles (e.g., air conditioning noise, non-speaker voices). Examples of output from AI include noise-removed audio waveforms, noise mask arrays (0.0-1.0), and SNR (signal-to-noise ratio) scores for each audio segment. The audio processing unit inputs noise-removed audio into the transcription model or analysis unit to reduce misrecognition rates of acoustic models. Furthermore, by dynamically switching filtering parameters and AI model weights according to the type and intensity of environmental noise, the unit adapts to various recording environments. As post-processing, the clarified audio data is used for transcription text generation, summarization and emotion analysis in the analysis unit, and registration in educational databases. Unlike conventional simple bandpass filters or manual noise removal by humans, the audio processing unit combines high-dimensional acoustic feature analysis by AI with dynamic noise removal, realizing optimal audio clarification and improved transcription accuracy according to recording environment and noise conditions. Technical effects include improved speech recognition accuracy, reduced misrecognition rate, adaptation to diverse recording environments, immediate application to education and quality management, and enhanced noise resistance. Specific application fields include analysis of call center call records, creation of meeting minutes, medical interview records in medical settings, lecture recordings in educational settings, and voice interfaces in noisy environments.

The audio processing unit can estimate a user's emotion and determine the priority of audio processing based on the estimated emotion. For example, the audio processing unit performs audio processing with normal priority when the user is relaxed. Additionally, the audio processing unit can prioritize processing of important audio when the user is nervous. Furthermore, the audio processing unit can prioritize processing of audio that reflects emotion when the user is excited. Thus, the audio processing unit can perform audio processing with optimal priority according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the audio processing unit may be performed using AI, or may be performed without using AI. For example, the audio processing unit can input user audio data into generative AI and have the generative AI determine the priority. Specifically, the audio processing unit simultaneously acquires user audio data (e.g., 1D float array sampled at 16 kHz, length 160,000 samples), facial images (1920×1080×3 RGB tensor), and posture information (30 frames of skeletal coordinate array), and inputs them into a multimodal emotion estimation model based on convolutional neural networks (CNN), recurrent neural networks (LSTM), and Transformer with self-attention mechanisms to output emotion labels (e.g., relaxed, nervous, excited) and emotion scores (e.g., relaxed: 0.75, nervous: 0.20, excited: 0.05). Examples of input to AI include arrays of audio waveforms for 10 seconds, one facial image tensor, and 30 frames of skeletal coordinate sequences. Examples of output from AI include emotion labels (relaxed, nervous, excited), emotion score vectors ([0.75, 0.20, 0.05]), and estimation confidence (0.91). Based on these emotion estimation results, the audio processing priority control module executes audio processing in utterance order as usual when the relaxed score is 0.7 or higher, prioritizes noise removal and emphasis processing for sections containing important keywords or technical terms when the nervous score is 0.5 or higher, and automatically detects sections where emotional expression is strong (e.g., parts with large voice inflection, parts where speech rate changes rapidly) and prioritizes emphasis processing and annotation when the excited score is 0.7 or higher. Examples of input for AI-based audio processing include noise-removed audio waveforms, emotion score vectors, and confidence scores for each utterance segment; examples of output include prioritized audio data, audio with important section labels, and audio with emotion annotations. As post-processing, prioritized audio data is used for summary generation in the transcription unit or analysis unit, educational feedback, and creation of quality management reports. Unlike conventional uniform audio processing order or subjective prioritization by humans, the audio processing unit combines emotion estimation in high-dimensional feature space by AI with dynamic priority control, realizing optimal audio processing order and content according to user state and on-site conditions. Technical effects include rapid grasp of important sections, immediate reflection of emotional changes, immediate application to education and quality management, and increased efficiency of records with emotion annotations. Specific application fields include analysis of call center call records, medical interview records in medical settings, lecture recordings in educational settings, automatic generation of minutes with emotion annotations, and educational records in customer service.

The audio processing unit can use echo canceling technology to improve audio clarity during audio processing. Echo canceling technology may include, for example, active echo canceling or passive echo canceling, but is not limited thereto. For example, the audio processing unit can use echo canceling technology to improve audio clarity. Additionally, the audio processing unit can use echo canceling technology to emphasize important audio. Furthermore, the audio processing unit can use echo canceling technology to remove background sounds. Thus, by using echo canceling technology, audio clarity can be improved. Some or all of the above-described processing in the audio processing unit may be performed using AI, or may be performed without using AI. For example, the audio processing unit can input audio data into generative AI and have the generative AI perform echo canceling. Specifically, the audio processing unit receives audio data (e.g., 1D float array sampled at 16 kHz, length 160,000 samples) as input, first extracts echo components using autocorrelation analysis or spectrogram conversion, and uses convolutional neural networks (CNN), autoregressive models (LSTM, GRU), or Transformer-based audio enhancement models to estimate echo masks and perform audio enhancement processing. Examples of input to AI include echo-contaminated audio waveforms, spectrogram images (256×256 2D float array), and environmental echo profiles (e.g., room reverberation characteristics, microphone placement information). Examples of output from AI include echo-removed audio waveforms, echo mask arrays (0.0-1.0), and SNR (signal-to-noise ratio) scores for each audio segment. The audio processing unit inputs echo-removed audio into the transcription model or analysis unit to reduce misrecognition rates of acoustic models. Furthermore, by dynamically switching filtering parameters and AI model weights according to the type and intensity of environmental echo, the unit adapts to various recording environments. As post-processing, the clarified audio data is used for transcription text generation, summarization and emotion analysis in the analysis unit, and registration in educational databases. Unlike conventional simple echo cancellers or manual echo removal by humans, the audio processing unit combines high-dimensional acoustic feature analysis by AI with dynamic echo removal, realizing optimal audio clarification and improved transcription accuracy according to recording environment and echo conditions. Technical effects include improved speech recognition accuracy, reduced misrecognition rate, adaptation to diverse recording environments, immediate application to education and quality management, and enhanced echo resistance. Specific application fields include analysis of call center call records, creation of meeting minutes, medical interview records in medical settings, lecture recordings in educational settings, and remote conference systems.

The classification unit can estimate a user's emotion and adjust classification criteria based on the estimated emotion. For example, the classification unit performs classification using normal criteria when the user is relaxed. Additionally, the classification unit can prioritize classification of important points when the user is nervous. Furthermore, the classification unit can prioritize classification of points that reflect emotion when the user is excited. Thus, the classification unit can perform classification using optimal criteria according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the classification unit may be performed using AI, or may be performed without using AI. For example, the classification unit can input user emotion data into generative AI and have the generative AI adjust classification criteria. Specifically, the classification unit simultaneously acquires user audio data (e.g., 1D float array sampled at 16 kHz, length 160,000 samples), facial images (1920×1080×3 RGB tensor), and posture information (30 frames of skeletal coordinate array), preprocesses them for noise removal and normalization, and inputs them into a multimodal emotion estimation model based on convolutional neural networks (CNN), recurrent neural networks (LSTM), and Transformer with self-attention mechanisms to output emotion labels (e.g., relaxed, nervous, excited) and emotion scores (e.g., relaxed: 0.80, nervous: 0.15, excited: 0.05). Examples of input to AI include arrays of audio waveforms for 10 seconds, one facial image tensor, and 30 frames of skeletal coordinate sequences. Examples of output from AI include emotion labels (relaxed), emotion score vectors ([0.80, 0.15, 0.05]), and estimation confidence (0.93). Based on these emotion estimation results, the classification criteria control module applies standard category classification algorithms (e.g., Transformer-based text classifier) when the relaxed score is 0.7 or higher, applies weighted classification models or stricter classification rules to prioritize classification of sections containing important keywords or technical terms when the nervous score is 0.5 or higher, and automatically detects sections where emotional expression is strong (e.g., parts with large voice inflection, parts where speech rate changes rapidly) and prioritizes classification with emotion labels when the excited score is 0.7 or higher. Examples of input for AI-based classification include noise-removed audio waveforms, emotion score vectors, and confidence scores for each utterance segment; examples of output include text with classification labels, classification results with important section labels, and classification results with emotion annotations. The classification unit executes dynamic adjustment of classification criteria in real time, realizing optimal classification accuracy and expressiveness according to user state and on-site conditions. Unlike conventional uniform classification criteria or subjective classification rules by humans, the classification unit combines emotion estimation in high-dimensional feature space by AI with dynamic classification criteria control, greatly improving classification accuracy, reproducibility, and application range. Technical effects include improved classification accuracy, rapid grasp of important sections, immediate reflection of emotional changes, immediate application to education and quality management, and increased efficiency of records with emotion annotations. Specific application fields include classification of educational records in customer service, classification of medical interview records in medical settings, classification of emotional utterances in psychological experiments, automatic classification of minutes with emotion annotations, and analysis of call center response records.

The classification unit can classify and organize the content of a talk by theme during classification. Classification by theme may include, for example, classification by topic or importance, but is not limited thereto. For example, the classification unit can classify and organize the content of a talk by theme. Additionally, the classification unit can classify and organize the content of a talk by category. Furthermore, the classification unit can classify the content of a talk by theme and extract important points. Thus, the classification unit can classify and organize the content of a talk by theme. Some or all of the above-described processing in the classification unit may be performed using AI, or may be performed without using AI. For example, the classification unit can input talk text data into generative AI and have the generative AI perform classification and organization by theme. Specifically, the classification unit receives the full text of the talk obtained from the transcription unit (e.g., UTF-8 encoded text of several thousand characters) as input, first performs morphological analysis and part-of-speech tagging, and generates feature vectors (e.g., BERT embedding vectors, dimension 768) for each sentence or utterance. The classification unit uses a pre-trained supervised multi-class classification model (e.g., Transformer-based text classifier, SVM, random forest, etc.) to classify each utterance or sentence into predefined categories such as ‘product explanation’, ‘closing’, ‘greeting’, or by importance (e.g., high, medium, low). Examples of input to AI include the full text of the talk, arrays of text by sentence, and category definition lists. Examples of output from AI include arrays of category labels for each sentence or utterance (e.g., [‘product explanation’, ‘closing’, ‘greeting’]), arrays of importance labels (e.g., [‘high’, ‘medium’, ‘low’]), and classification confidence scores (e.g., 0.85, 0.60, 0.95). Based on the classification results, the classification unit organizes the content of the talk by category or theme and applies important point extraction algorithms (e.g., extraction of frequently occurring phrases within categories, extraction of top importance scores). As post-processing, the content of the talk organized by category is used for graph generation in the visualization unit, creation of educational materials, and generation of quality management reports. Unlike conventional subjective classification by humans or simple keyword matching, the classification unit realizes pattern learning and context-dependent classification in high-dimensional feature space by AI, greatly improving classification accuracy, reproducibility, and processing speed. Technical effects include improved automatic classification accuracy of talk content, efficient extraction of important points, immediate application to education and quality management, and increased efficiency of knowledge sharing. Specific application fields include evaluation of talk quality in customer service, automatic classification of sales talks, organization of interview content in medical settings, automatic tagging of minutes, and analysis of call center response records.

The classification unit can estimate a user's emotion and adjust the display method of classification results based on the estimated emotion. For example, the classification unit provides classification results using a normal display method when the user is relaxed. Additionally, the classification unit can provide classification results using a highly visible display method when the user is nervous. Furthermore, the classification unit can provide classification results using a display method that reflects emotion when the user is excited. Thus, the classification unit can provide classification results using the optimal display method according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the classification unit may be performed using AI, or may be performed without using AI. For example, the classification unit can input user emotion data into generative AI and have the generative AI adjust the display method. Specifically, the classification unit receives user emotion estimation results (e.g., emotion labels such as relaxed, nervous, excited and emotion score vectors [0.80, 0.10, 0.10]) as input, and dynamically switches the display format of classification results (e.g., color, font size, emphasis level, animation effects) and information granularity (e.g., summary level, detail level) in the display method control module. The classification unit uses multimodal data such as facial images, audio waveforms, and posture information for emotion estimation, and performs estimation using convolutional neural networks (CNN), recurrent neural networks (LSTM), and Transformer-based emotion estimation models. Examples of input to AI include arrays of audio waveforms for 10 seconds, one facial image tensor, and 30 frames of skeletal coordinate sequences. Examples of output from AI include emotion labels (relaxed), emotion score vectors ([0.80, 0.10, 0.10]), and estimation confidence (0.93). The classification unit displays classification results using standard graphs or charts and normal colors and fonts when the relaxed score is 0.7 or higher, applies high-contrast colors, large fonts, and highlight display of important points to improve visibility when the nervous score is 0.5 or higher, and uses animation effects and emotional colors (e.g., red, yellow) and generates classification results or graphs with emotion annotations to emphasize emotional expression when the excited score is 0.7 or higher. The classification unit executes these display method switches in real time to provide optimal information presentation according to the user's state and usage scene. As post-processing, the adjusted display results are passed to the visualization unit, user interface, and educational material generation module. Unlike conventional uniform display formats or manual adjustment by humans, the classification unit combines emotion estimation in high-dimensional feature space by AI with dynamic display control, greatly improving user experience, comprehension, and educational effectiveness. Technical effects include improved visibility and comprehension, automatic reflection of emotional nuances, immediate application to education and quality management, and realization of interactive information presentation. Specific application fields include generation of educational materials for customer service, display of classification results for patient interviews in medical settings, visualization of emotional changes in psychological experiments, display of minutes with emotion annotations, and evaluation of call center operators.

The classification unit can classify and display the content of a talk in chronological order during classification. Classification in chronological order may include, for example, time order or event order, but is not limited thereto. For example, the classification unit can classify and display the content of a talk in chronological order. Additionally, the classification unit can classify and display important points of a talk in chronological order. Furthermore, the classification unit can classify and visually display the content of a talk in chronological order. Thus, the classification unit can classify and display the content of a talk in chronological order. Some or all of the above-described processing in the classification unit may be performed using AI, or may be performed without using AI. For example, the classification unit can input talk text data into generative AI and have the generative AI perform classification and display in chronological order. Specifically, the classification unit receives the full text of the talk and timestamp data for each utterance (e.g., start and end times for each utterance) obtained from the transcription unit as input, first performs chronological sorting by utterance, and generates feature vectors (e.g., BERT embedding vectors, dimension 768) for each utterance or sentence. The classification unit uses time-series analysis models (e.g., LSTM, Transformer Encoder) and pre-trained supervised classification models to classify each utterance into chronological categories such as ‘introduction’, ‘product explanation’, ‘closing’, or by importance. Examples of input to AI include arrays of text by utterance, arrays of timestamps, and category definition lists. Examples of output from AI include arrays of category labels in chronological order (e.g., [‘introduction’, ‘product explanation’, ‘closing’]), arrays of importance labels, and classification confidence scores. Based on the classification results, the classification unit automatically generates chronological graphs or timeline charts and highlights important points. Furthermore, the unit applies change point detection algorithms for time-series (e.g., detection of segments with sudden changes in utterance content) to visualize event transitions and emotional changes. As post-processing, classification results organized in chronological order are used for timeline display in the visualization unit, creation of educational materials, and generation of quality management reports. Unlike conventional static classification or manual chronological organization by humans, the classification unit combines time-series analysis in high-dimensional feature space by AI with automatic classification, greatly improving classification accuracy, reproducibility, and information searchability. Technical effects include improved chronological classification accuracy, immediate grasp of event changes, immediate application to education and quality management, and increased efficiency of knowledge sharing. Specific application fields include chronological classification of meeting minutes, process analysis of sales talks, chronological organization of medical interview records in medical settings, timeline display of minutes, and analysis of call center response records.

The display unit can estimate a user's emotion and adjust the display method based on the estimated emotion. For example, the display unit provides results using a normal display method when the user is relaxed. Additionally, the display unit can provide results using a highly visible display method when the user is nervous. Furthermore, the display unit can provide results using a display method that reflects emotion when the user is excited. Thus, the display unit can provide results using the optimal display method according to the user's emotion. Emotion estimation is realized, for example, by using an emotion engine or generative AI with emotion estimation functions. Generative AI may be text generation AI (e.g., LLM) or multimodal generative AI, but is not limited thereto. Some or all of the above-described processing in the display unit may be performed using AI, or may be performed without using AI. For example, the display unit can input user emotion data into generative AI and have the generative AI adjust the display method.

The display unit can emphasize important phrases of a talk during display. Important phrases may include, for example, keyword extraction or font changes, but are not limited thereto. For example, the display unit can emphasize important phrases of a talk. Additionally, the display unit can highlight important phrases of a talk. Furthermore, the display unit can visually emphasize important phrases of a talk. Thus, by emphasizing important phrases of a talk, key points can be clarified. Some or all of the above-described processing in the display unit may be performed using AI, or may be performed without using AI. For example, the display unit can input talk analysis data into generative AI and have the generative AI perform emphasis of important phrases.

The display unit can estimate a user's emotion and determine the display priority based on the estimated emotion of the user. For example, when the user is relaxed, the display unit performs display with normal priority. When the user is tense, the display unit can prioritize the display of important points. Furthermore, when the user is excited, the display unit can prioritize the display of points that reflect the user's emotion. In this way, the display can be performed with optimal priority according to the user's emotion. Emotion estimation is realized, for example, by using an emotion estimation function such as an emotion engine or generative AI. The generative AI may be a text generation AI (for example, LLM) or a multimodal generative AI, but is not limited to these examples. Some or all of the above-described processing in the display unit may be performed using AI or without using AI. For example, the display unit can input the user's emotion data to generative AI and have the generative AI execute the determination of priority.

The display unit can highlight the content of the talk with keywords during display. Highlighting with keywords may include, for example, changing colors or fonts, but is not limited to these examples. For example, the display unit can highlight the content of the talk with keywords. The display unit can also emphasize the content of the talk with important keywords. Furthermore, the display unit can visually emphasize the content of the talk with keywords. By highlighting the content of the talk with keywords, important points can be emphasized. Some or all of the above-described processing in the display unit may be performed using AI or without using AI. For example, the display unit can input analysis data of the talk to generative AI and have the generative AI execute the highlighting of keywords.

The system according to the embodiment is not limited to the above-described examples, and various modifications are possible, for example, as described below.

The imaging unit can estimate a user's emotion and adjust the timing of capturing based on the estimated emotion of the user. For example, when the user is relaxed, the timing of capturing is adjusted to capture natural facial expressions and actions. When the user is tense, capturing may be started after waiting for the user to relax. Furthermore, when the user is excited, capturing may be started immediately to capture that emotion. In this way, capturing can be performed at the optimal timing according to the user's emotion.

The imaging unit can use a high-resolution camera during capturing to record crew actions or facial expressions in detail. For example, a high-resolution camera can be used to capture subtle changes in crew facial expressions. A high-resolution camera can also be used to record crew gestures or body language in detail. Furthermore, a high-resolution camera can be used to smoothly capture crew actions. In this way, subtle facial expressions and actions of the crew can be recorded in detail.

The imaging unit can use multiple camera angles during capturing to comprehensively capture the overall scene of the talk from various perspectives. For example, multiple cameras can be used to simultaneously capture images of the crew from the front, side, and back. Multiple cameras can also be used to capture crew actions or facial expressions from different angles. Furthermore, multiple cameras can be used to comprehensively record the overall scene of the talk from various perspectives. In this way, the overall scene of the talk can be comprehensively captured from various perspectives.

The imaging unit can estimate a user's emotion and determine the priority of scenes to be captured based on the estimated emotion of the user. For example, when the user is relaxed, natural scenes are prioritized for capturing. When the user is tense, scenes that help the user relax may be prioritized for capturing. Furthermore, when the user is excited, scenes that capture that emotion may be prioritized for capturing. In this way, the optimal scenes can be prioritized for capturing according to the user's emotion.

The imaging unit can select an optimal capturing environment during capturing by considering crew background sounds or environmental sounds. For example, a quiet environment with little background sound can be selected for capturing. Alternatively, a location with moderate environmental sounds can be selected to create a natural atmosphere. Furthermore, optimal microphone settings can be made by considering background sounds or environmental sounds. In this way, the optimal capturing environment can be selected by considering background sounds or environmental sounds.

The transcription unit can estimate a user's emotion and adjust the accuracy of transcription based on the estimated emotion of the user. For example, when the user is relaxed, transcription is performed with normal accuracy. When the user is tense, transcription can be performed with higher accuracy. Furthermore, when the user is excited, transcription that reflects the user's emotion can be performed. In this way, the accuracy of transcription can be adjusted according to the user's emotion.

The transcription unit can automatically recognize and accurately transcribe technical terms or industry-specific terminology during transcription. For example, technical terms can be automatically recognized and accurately transcribed. Industry-specific terminology can also be automatically recognized and accurately transcribed. Furthermore, technical terms or industry-specific terminology can be registered in a dictionary to improve transcription accuracy. In this way, technical terms or industry-specific terminology can be accurately transcribed.

The transcription unit can adjust the timing of transcription according to the speed or rhythm of the talk during transcription. For example, the timing of transcription can be adjusted according to the speed of the talk. The timing of transcription can also be adjusted according to the rhythm of the talk. Furthermore, the speed or rhythm of the talk can be analyzed to perform transcription at the optimal timing. In this way, transcription can be performed at the optimal timing according to the speed or rhythm of the talk.

The analysis unit can estimate a user's emotion and adjust the analysis algorithm based on the estimated emotion of the user. For example, when the user is relaxed, analysis is performed using a normal algorithm. When the user is tense, analysis can be performed using an algorithm with higher accuracy. Furthermore, when the user is excited, analysis can be performed using an algorithm that reflects the user's emotion. In this way, analysis can be performed using the optimal algorithm according to the user's emotion.

The analysis unit can extract important points by considering the context or background information of the talk during analysis. For example, the context of the talk can be analyzed to extract important points. Important points can also be extracted by considering the background information of the talk. Furthermore, the context and background information of the talk can be comprehensively analyzed to extract the most important points. In this way, important points can be extracted by considering the context or background information of the talk.

The processing flow of Example of the Embodiment will be briefly described below.

Step 1: The imaging unit captures a talk. The talk may include a presentation, meeting, interview, and the like, but is not limited thereto. For example, a talk by an excellent crew may be captured using ZOOM, and talks during customer service or product explanation may be captured. At this time, by capturing the crew's facial expressions and gestures as well, more detailed information can be obtained.

Step 2: The transcription unit transcribes the talk captured by the imaging unit. Transcription may include speech recognition technology or manual input, but is not limited thereto. For example, the transcription function of ZOOM may be used to automatically transcribe the content of the talk. The transcribed talk is used as data for later analysis.
Step 3: The analysis unit analyzes the talk transcribed by the transcription unit. Analysis may include keyword extraction or emotion analysis, but is not limited thereto. For example, SmartAI-Chat uses AI to analyze the content of the talk and extract important points. Important phrases during customer service or key points of product explanation can be extracted.
Step 4: The visualization unit visualizes points of the talk analyzed by the analysis unit. Visualization may include graph display or highlight display, but is not limited thereto. For example, by visually displaying with graphs or charts, the key points of the talk can be grasped at a glance.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https: //openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned imaging unit, transcription unit, analysis unit, and visualization unit is implemented, for example, in at least one of a smart device 14 and a data processing apparatus 12. For example, the imaging unit captures a talk using a camera 42 of the smart device 14, and the transcription unit transcribes the talk by a control unit 46A of the smart device 14. The analysis unit analyzes the content of the talk by a specific processing unit 290 of the data processing apparatus 12, and the visualization unit visually displays the analysis result by the control unit 46A of the smart device 14. The correspondence between each unit and the device or control unit is not limited to the examples described above and various modifications are possible.

### Second Embodiment

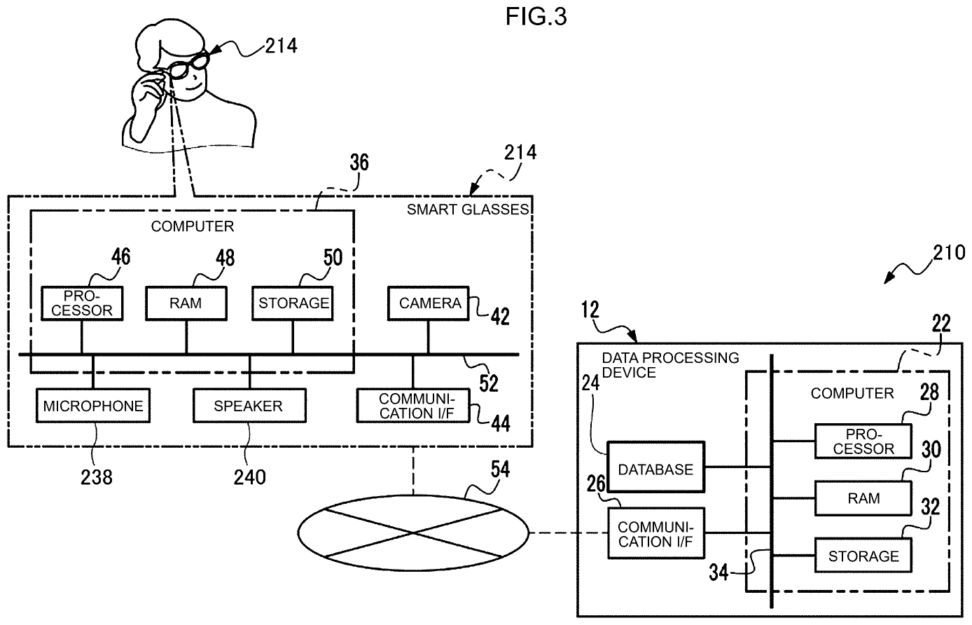

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

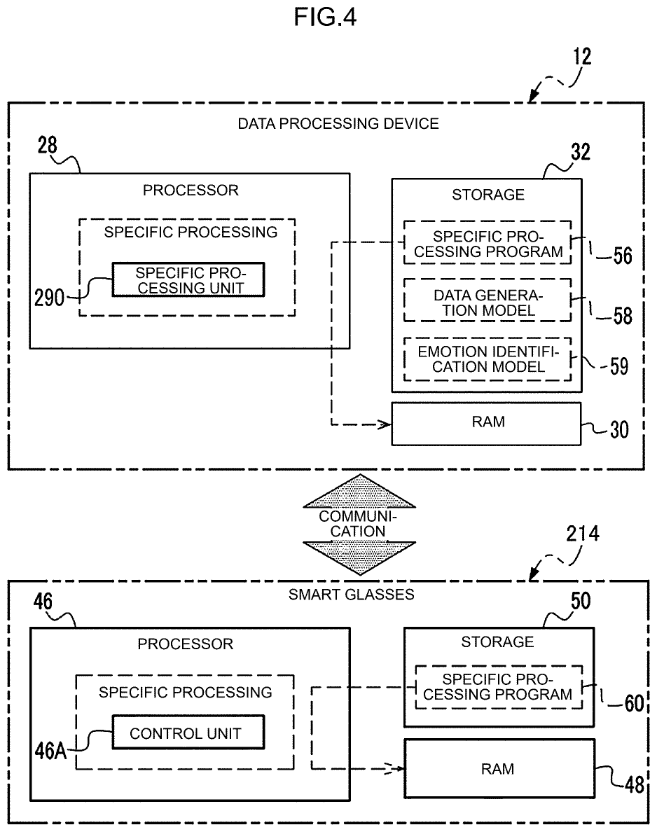

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned imaging unit, transcription unit, analysis unit, and visualization unit is implemented, for example, in at least one of smart glasses 214 and a data processing apparatus 12. For example, the imaging unit captures a talk using a camera 42 of the smart glasses 214, and the transcription unit transcribes the talk by a control unit 46A of the smart glasses 214. The analysis unit analyzes the content of the talk by a specific processing unit 290 of the data processing apparatus 12, and the visualization unit visually displays the analysis result by the control unit 46A of the smart glasses 214. The correspondence between each unit and the device or control unit is not limited to the examples described above and various modifications are possible.

### Third Embodiment

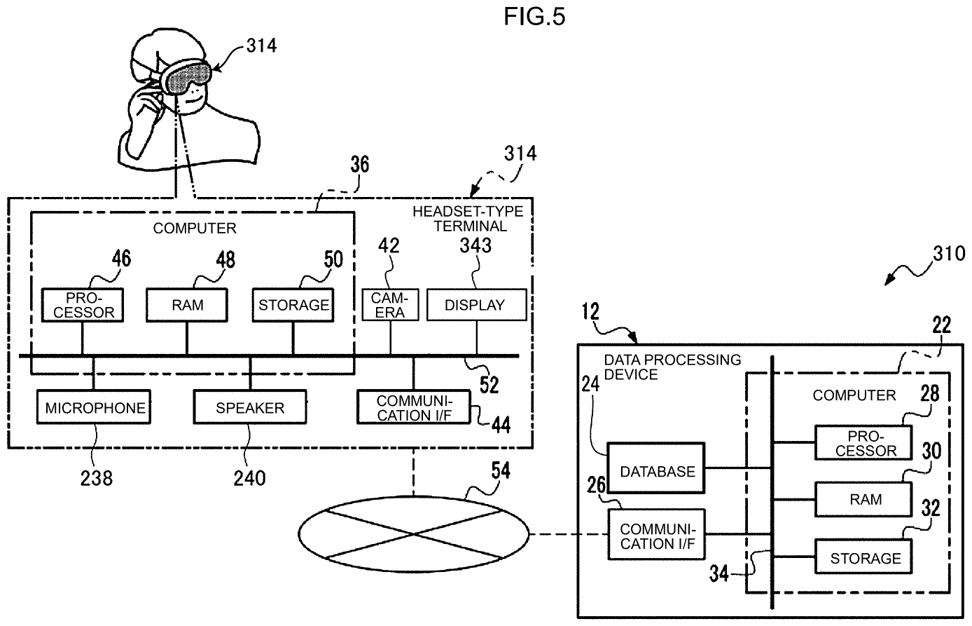

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

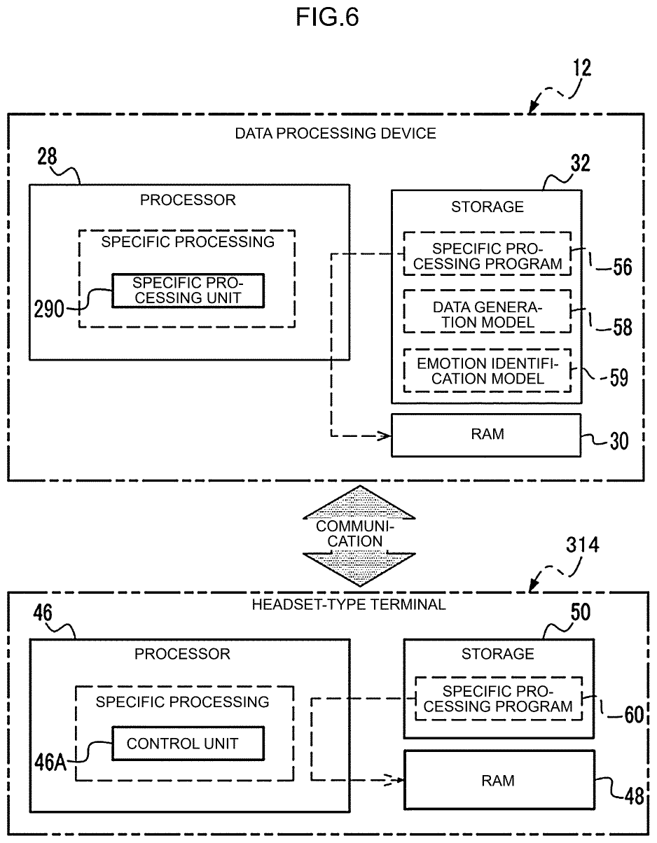

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned imaging unit, transcription unit, analysis unit, and visualization unit is implemented, for example, in at least one of a headset-type terminal 314 and a data processing apparatus 12. For example, the imaging unit captures a talk using a camera 42 of the headset-type terminal 314, and the transcription unit transcribes the talk by a control unit 46A of the headset-type terminal 314. The analysis unit analyzes the content of the talk by a specific processing unit 290 of the data processing apparatus 12, and the visualization unit visually displays the analysis result by the control unit 46A of the headset-type terminal 314. The correspondence between each unit and the device or control unit is not limited to the examples described above and various modifications are possible.

### Fourth Embodiment

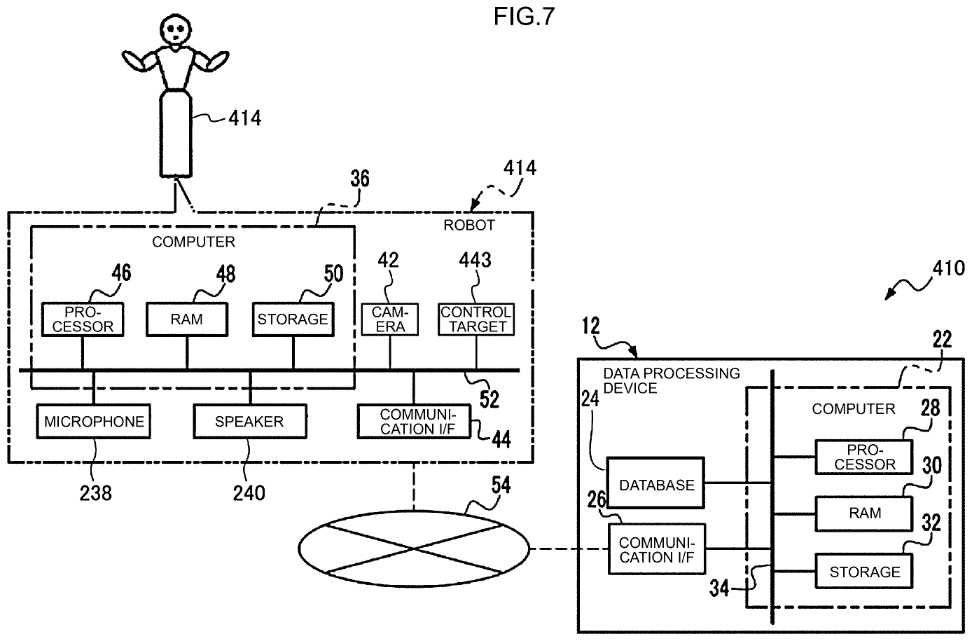

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

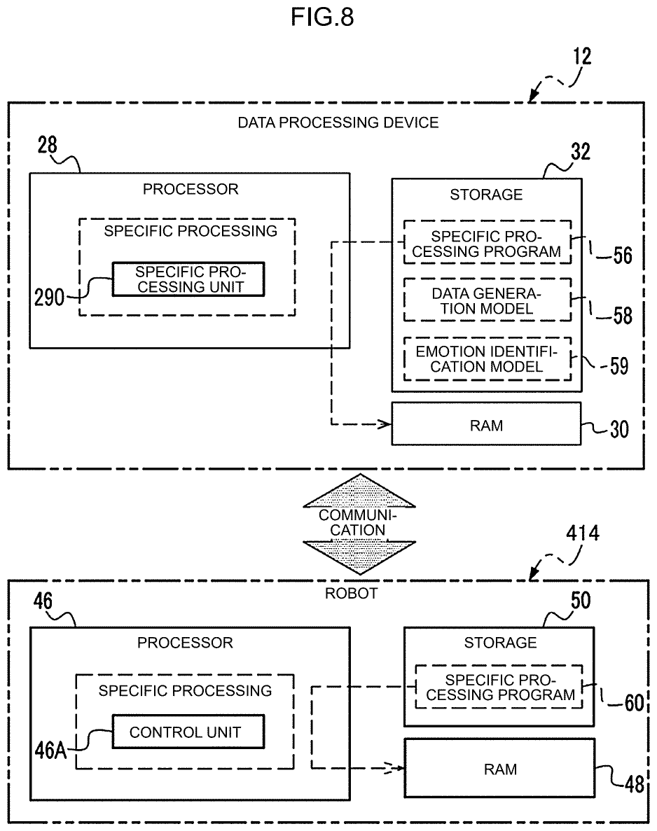

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned imaging unit, transcription unit, analysis unit, and visualization unit is implemented, for example, in at least one of a robot 414 and a data processing apparatus 12. For example, the imaging unit captures a talk using a camera 42 of the robot 414, and the transcription unit transcribes the talk by a control unit 46A of the robot 414. The analysis unit analyzes the content of the talk by a specific processing unit 290 of the data processing apparatus 12, and the visualization unit visually displays the analysis result by the control unit 46A of the robot 414. The correspondence between each unit and the device or control unit is not limited to the examples described above and various modifications are possible.

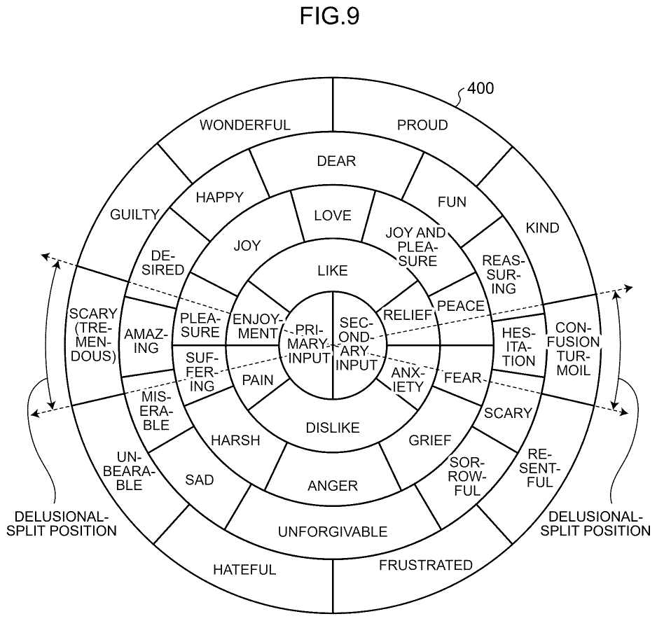

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

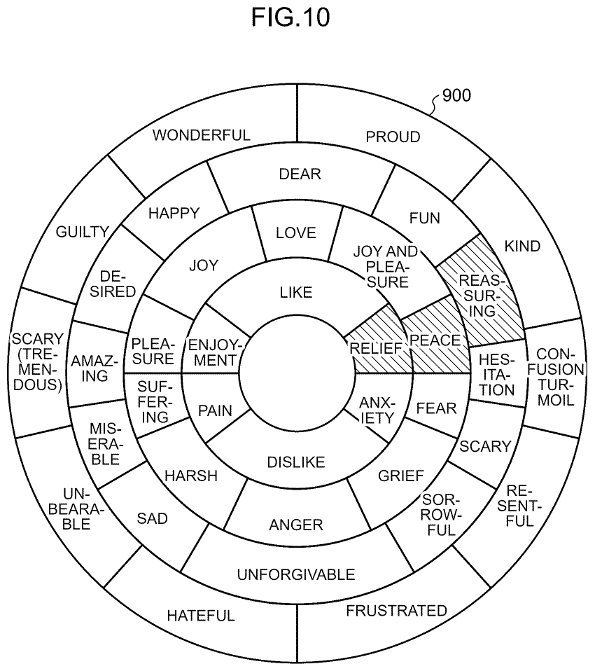

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1)A system comprising: an imaging unit configured to capture a talk; a transcription unit configured to transcribe the talk captured by the imaging unit; an analysis unit configured to analyze the talk transcribed by the transcription unit; and a visualization unit configured to visualize points of the talk analyzed by the analysis unit.
(Supplementary Note 2)The system according to Supplementary Note 1, wherein the imaging unit comprises an audio processing unit that uses noise canceling or voice filtering technology.
(Supplementary Note 3)The system according to Supplementary Note 1, wherein the analysis unit comprises a classification unit configured to classify the content of the talk.
(Supplementary Note 4)The system according to Supplementary Note 1, wherein the visualization unit comprises a display unit configured to highlight keywords or emphasize important phrases.
(Supplementary Note 5)The system according to Supplementary Note 1, wherein the imaging unit is configured to estimate a user's emotion and adjust the timing of capturing based on the estimated emotion of the user.
(Supplementary Note 6)The system according to Supplementary Note 1, wherein the imaging unit uses a high-resolution camera to record crew actions or facial expressions in detail during capturing.
(Supplementary Note 7)The system according to Supplementary Note 1, wherein the imaging unit uses multiple camera angles during capturing to comprehensively capture the overall scene of the talk from various perspectives.
(Supplementary Note 8)The system according to Supplementary Note 1, wherein the imaging unit is configured to estimate a user's emotion and determine the priority of scenes to be captured based on the estimated emotion of the user.
(Supplementary Note 9)The system according to Supplementary Note 1, wherein the imaging unit is configured to select an optimal capturing environment during capturing by considering crew background sounds or environmental sounds.
(Supplementary Note 10)The system according to Supplementary Note 1, wherein the imaging unit uses motion capture technology during capturing to analyze crew gestures or body language.
(Supplementary Note 11)The system according to Supplementary Note 1, wherein the transcription unit is configured to estimate a user's emotion and adjust the accuracy of transcription based on the estimated emotion of the user.
(Supplementary Note 12)The system according to Supplementary Note 1, wherein the transcription unit is configured to automatically recognize and accurately transcribe technical terms or industry-specific terminology during transcription.
(Supplementary Note 13)The system according to Supplementary Note 1, wherein the transcription unit is configured to adjust the timing of transcription according to the speed or rhythm of the talk during transcription.
(Supplementary Note 14)The system according to Supplementary Note 1, wherein the transcription unit is configured to estimate a user's emotion and determine the priority of transcription based on the estimated emotion of the user.
(Supplementary Note 15)The system according to Supplementary Note 1, wherein the transcription unit is configured to add a function to automatically translate into multiple languages during transcription.
(Supplementary Note 16)The system according to Supplementary Note 1, wherein the transcription unit is configured to remove background sounds or noise during transcription to generate clear audio data.
(Supplementary Note 17)The system according to Supplementary Note 1, wherein the analysis unit is configured to estimate a user's emotion and adjust the analysis algorithm based on the estimated emotion of the user.
(Supplementary Note 18)The system according to Supplementary Note 1, wherein the analysis unit is configured to extract important points by considering the context or background information of the talk during analysis.
(Supplementary Note 19)The system according to Supplementary Note 1, wherein the analysis unit is configured to analyze the content of the talk in real time during analysis and provide results immediately.
(Supplementary Note 20)The system according to Supplementary Note 1, wherein the analysis unit is configured to estimate a user's emotion and adjust the display method of analysis results based on the estimated emotion of the user.
(Supplementary Note 21)The system according to Supplementary Note 1, wherein the analysis unit is configured to classify and organize the content of the talk by category during analysis.
(Supplementary Note 22)The system according to Supplementary Note 1, wherein the analysis unit is configured to improve accuracy by matching the content of the talk with other related data during analysis.
(Supplementary Note 23)The system according to Supplementary Note 1, wherein the visualization unit is configured to estimate a user's emotion and adjust the visualization method based on the estimated emotion of the user.
(Supplementary Note 24)The system according to Supplementary Note 1, wherein the visualization unit is configured to visually display important points of the talk in graphs or charts during visualization.
(Supplementary Note 25)The system according to Supplementary Note 1, wherein the visualization unit is configured to summarize and concisely display the content of the talk during visualization.
(Supplementary Note 26)The system according to Supplementary Note 1, wherein the visualization unit is configured to estimate a user's emotion and determine the priority of visualization based on the estimated emotion of the user.
(Supplementary Note 27)The system according to Supplementary Note 1, wherein the visualization unit is configured to display the content of the talk in an interactive format during visualization.
(Supplementary Note 28)The system according to Supplementary Note 1, wherein the visualization unit is configured to link and display the content of the talk with other related information during visualization.
(Supplementary Note 29)The system according to Supplementary Note 2, wherein the audio processing unit is configured to estimate a user's emotion and adjust audio processing filtering based on the estimated emotion of the user.
(Supplementary Note 30)The system according to Supplementary Note 2, wherein the audio processing unit is configured to remove background sounds using noise canceling technology during audio processing.
(Supplementary Note 31)The system according to Supplementary Note 2, wherein the audio processing unit is configured to estimate a user's emotion and determine the priority of audio processing based on the estimated emotion of the user.
(Supplementary Note 32)The system according to Supplementary Note 2, wherein the audio processing unit uses echo canceling technology during audio processing to improve audio clarity.
(Supplementary Note 33)The system according to Supplementary Note 3, wherein the classification unit is configured to estimate a user's emotion and adjust classification criteria based on the estimated emotion of the user.
(Supplementary Note 34)The system according to Supplementary Note 3, wherein the classification unit is configured to classify and organize the content of the talk by theme during classification.
(Supplementary Note 35)The system according to Supplementary Note 3, wherein the classification unit is configured to estimate a user's emotion and adjust the display method of classification results based on the estimated emotion of the user.
(Supplementary Note 36)The system according to Supplementary Note 3, wherein the classification unit is configured to classify and display the content of the talk in chronological order during classification.
(Supplementary Note 37)The system according to Supplementary Note 4, wherein the display unit is configured to estimate a user's emotion and adjust the display method based on the estimated emotion of the user.
(Supplementary Note 38)The system according to Supplementary Note 4, wherein the display unit is configured to emphasize important phrases of the talk during display.
(Supplementary Note 39)The system according to Supplementary Note 4, wherein the display unit is configured to estimate a user's emotion and determine the priority of display based on the estimated emotion of the user.
(Supplementary Note 40)The system according to Supplementary Note 4, wherein the display unit is configured to highlight keywords of the talk during display.

What is claimed is:

1. A system comprising:
a communication interface configured to communicate with a client terminal via a packet-switched network;
a memory storing a speech recognition model and a natural language processing model, each obtained by machine learning on a neural network; and
circuitry configured to:
receive, from the client terminal via the communication interface, audio data and video data representing a talk captured by a camera and a microphone of the client terminal;
convert the audio data into transcription text by inputting the audio data into the speech recognition model;
analyze the transcription text by inputting the transcription text into the natural language processing model to extract at least one of a keyword, a topic label, or a sentiment score;
generate visualization data comprising at least one of a graph, a chart, or a highlight display based on the extracted keyword, topic label, or sentiment score; and
transmit the visualization data to the client terminal via the communication interface and the packet-switched network, the visualization data causing the client terminal to render a visual representation of points of the talk.

2. The system according to claim 1, wherein the speech recognition model comprises at least one of a convolutional neural network, a recurrent neural network, or a Transformer-based model, and wherein converting the audio data comprises extracting acoustic features comprising at least one of mel-frequency cepstral coefficients or a spectrogram from the audio data.

3. The system according to claim 1, wherein the natural language processing model comprises a Transformer-based large language model, and wherein analyzing the transcription text comprises tokenizing the transcription text, generating embedding vectors from the tokenized text, and classifying each statement as at least one of positive, neutral, or negative.

4. The system according to claim 1, wherein the circuitry is further configured to extract, from the video data, facial image data and posture data of a speaker, and to analyze the facial image data and the posture data to extract nonverbal communication features.

5. The system according to claim 1, wherein the circuitry is further configured to perform noise canceling on the audio data by estimating a noise mask using a neural network and subtracting estimated noise from the audio data before inputting the audio data into the speech recognition model.

6. The system according to claim 1, wherein the circuitry is further configured to automatically recognize technical terms or industry-specific terminology in the transcription text by applying a custom dictionary comprising term entries for a specific domain.

7. The system according to claim 1, wherein the circuitry is further configured to estimate an emotion of a user by applying an emotion identification model to at least one of the audio data or the video data, and to adjust a timing of receiving the audio data and the video data based on the estimated emotion.

8. The system according to claim 7, wherein the circuitry is further configured to adjust an accuracy parameter of the speech recognition model based on the estimated emotion, the accuracy parameter comprising at least one of a beam search width or a noise suppression level.

9. The system according to claim 7, wherein the circuitry is further configured to adjust a display format of the visualization data based on the estimated emotion, such that when the estimated emotion indicates relaxation, the visualization data comprises a detailed format, and when the estimated emotion indicates nervousness, the visualization data comprises a simplified format with high-contrast colors.

10. The system according to claim 1, wherein the circuitry is further configured to classify the transcription text into a plurality of categories comprising at least one of a topic category, an importance category, or a chronological category, and to organize the visualization data according to the classified categories.

11. The system according to claim 1, wherein the circuitry is further configured to analyze the transcription text in real time by processing the audio data in streaming batches, and to update the visualization data incrementally as new transcription text is generated.

12. The system according to claim 1, wherein the circuitry is further configured to extract important phrases from the transcription text by applying an attention mechanism to identify phrases with high importance scores, and to generate the visualization data with the important phrases highlighted.

13. The system according to claim 1, wherein the circuitry is further configured to generate a summary of the transcription text using a summarization model, the summary comprising a condensed natural-language representation of points of the talk.

14. The system according to claim 1, wherein the circuitry is further configured to translate the transcription text into a plurality of languages using a neural machine translation model, and to transmit multilingual visualization data to the client terminal.

15. The system according to claim 1, wherein the circuitry is further configured to receive video data from a plurality of cameras capturing the talk from different angles, and to integrate the video data from the plurality of cameras to generate a comprehensive analysis of the talk.

16. The system according to claim 1, wherein the circuitry is further configured to analyze gestures or body language of a speaker in the video data using a motion capture model comprising at least one of a skeleton estimation model or a pose detection model.

17. The system according to claim 1, wherein the visualization data comprises at least one of a bar graph showing frequency of keywords, a pie chart showing distribution of topic categories, a timeline showing chronological progression of the talk, or highlighted text with color-coded sentiment indicators.

18. A system comprising:
a communication interface configured to communicate, via a packet-switched network conforming to at least one of a 5G, Wi-Fi, or Bluetooth communication standard, with a client terminal comprising a camera having a CMOS image sensor, a microphone, a speaker, and a display;
a processor;
a random-access memory;
a memory storing a speech recognition model comprising a Transformer-based encoder-decoder architecture obtained by deep learning on a neural network, a natural language processing model comprising a Transformer-based large language model, and an emotion identification model; and
circuitry configured to:
receive, from the client terminal via the communication interface, audio data captured by the microphone and video data captured by the camera, the audio data and the video data representing a talk;
extract acoustic features comprising at least one of mel-frequency cepstral coefficients or a spectrogram from the audio data;
convert the acoustic features into transcription text by determining an optimal character string sequence using at least one of a beam search decoder or a connectionist temporal classification decoder of the speech recognition model;
analyze the transcription text by tokenizing the transcription text and inputting tokens into the natural language processing model to extract at least one of a keyword, a topic label, or a sentiment score;
estimate an emotion of a user by applying the emotion identification model to at least one of the audio data or the video data;
generate visualization data comprising at least one of a graph, a chart, or a highlight display based on the extracted keyword, topic label, or sentiment score, the visualization data being adapted based on the estimated emotion; and
transmit the visualization data to the client terminal via the communication interface, the visualization data causing the client terminal to render a visual representation of points of the talk via the display.

19. The system according to claim 18, wherein the memory further stores a data generation model comprising at least one of a text generation AI, an image generation AI, or a multimodal generation AI, and wherein the data generation model is a fine-tuned model configured to output inference results from prompts without instructions.

20. A method performed by circuitry of a system comprising a communication interface, a memory storing a speech recognition model and a natural language processing model each obtained by machine learning on a neural network, the method comprising:
receiving, from a client terminal via the communication interface and a packet-switched network, audio data and video data representing a talk captured by a camera and a microphone of the client terminal;
converting the audio data into transcription text by inputting the audio data into the speech recognition model;
analyzing the transcription text by inputting the transcription text into the natural language processing model to extract at least one of a keyword, a topic label, or a sentiment score;
generating visualization data comprising at least one of a graph, a chart, or a highlight display based on the extracted keyword, topic label, or sentiment score; and
transmitting the visualization data to the client terminal via the communication interface and the packet-switched network, the visualization data causing the client terminal to render a visual representation of points of the talk.
